(19) United States
(12) Patent Application Publication
(10) Pub. No.: US 2026/0048660 A1
(43) Pub. Date: Feb. 19, 2026

(54) MULTI-USER EXPERIENCE RESTRICTIONS FOR VEHICLE OPERATING SYSTEMS

(71) Applicant: Google LLC, Mountain View, CA (US)

(72) Inventors: Shashank Goel, Milpitas, CA (US); Xiang Wang, Menlo Park, CA (US); Keun Young Park, Santa Clara, CA (US); Felipe Leme, Belmont, CA (US); Yun Cheol Heo, Sunnyvale, CA (US)

(21) Appl. No.: 19/101,768

(22) PCT Filed: Aug. 10, 2023
(86) PCT No.: PCT/US2023/072003

§ 371 Date: Feb. 6, 2025

Related U.S. Application Data
(60) Provisional application No. 63/371,445, filed on Aug. 15, 2022.
(60) Provisional application No. 63/371,451, filed on Aug. 15, 2022.

(51) Int. Cl. B60K 35/29; B60K 35/22; G06F 3/14

(52) U.S. Cl. CPC B60K 35/29; B60K 35/22; G06F 3/1423

(57) ABSTRACT

A computing device comprising a memory configured to store an instance of a vehicle operating system (“VOS,” where the in stance of the vehicle operating system facilitates concurrent access by multiple user profiles) and processing circuitry configured to execute the instance of the VOS. The VOS may authorize the multiple user profiles to interface with the instance of the vehicle operating system via multiple displays communicatively coupled to the vehicle head unit, and, determine, based on which of the multiple displays with which each of the multiple user profiles interfaced to authorize each of the multiple user profiles, occupant zone identifiers. The VOS may also obtain, based on the occupant zone identifiers, and for each of the multiple user profiles, user experience restrictions, and restrict, via multiple user interfaces presented across the multiple displays by the single instance of the VOS and in accordance with the user experience restrictions, content.

This application claims priority to U.S. Provisional Application Ser. No. 63/371,445, entitled “CONTEXT AWARE SAFETY FEATURES FOR VEHICLE OPERATING SYSTEMS,” filed Aug. 15, 2022, and U.S. Provisional Application Ser. No. 63/371,451, entitled “SINGLE-INSTANCE MULTI-USER SUPPORT FOR VEHICLE OPERATING SYSTEMS,” filed Aug. 15, 2022, each of which is incorporated by reference as if set out in their respective entireties herein.

### BACKGROUND

A vehicle head unit (which may be referred to as an infotainment system) may be configured to execute a vehicle operating system to facilitate control of, to provide a few examples, entertainment (such as music, video, images, etc.), information, navigation, and voice calls, as well as vehicle systems, such as heating, ventilation, and air conditioning (HVAC) systems, lighting systems, and seat control systems (including heating and/or cooling, seat adjustment, etc.). Vehicle operating systems may enable a single user profile to access a given instance of the vehicle operating system, where the single user profile is typically the operator of the vehicle. While the instance of the vehicle operating system may support multiple user profiles, the instance of the vehicle operating system may only allow a single user profile of the multiple user profiles to access (or in other words “log into”) the instance of the vehicle operating system. The instance of the vehicle operating system may limit access to a single user profile to ensure that the operator of the vehicle does not become distracted by other user profile behavior while operating the vehicle.

### SUMMARY

In general, various aspects of the techniques set forth in this disclosure are directed to a single instance of a vehicle operating system that provides concurrent multi-user support. Rather than limit access to a single user profile for the single instance of the vehicle operating system, a single instance of the vehicle operating system described in this disclosure may allow multiple user profiles to access the single instance of the vehicle operating system. As vehicles have begun integrating increasingly more displays in a cabin of the vehicle, more users may safely interface with the vehicle operating system without distracting an operator of the vehicle (considering that in some examples, the operator either has limited view of these displays or has no direct view of these displays, which may be disposed behind the operator for rear seat passengers). As such, multiple users associated with multiple user profiles may access the vehicle operating systems and interact with the vehicle to control various functionality provided via the vehicle head unit, such as entertainment, information, navigation, and voice calls as well as various vehicle systems (which may be, to some extent, dependent on the multiple user locations within the vehicle).

The multiple users may also interface with the vehicle operating system to jointly coordinate activities among the multiple users, such as sharing content between the multiple users, reviewing content viewed by other users of the multiple users, control audio playback between the multiple users (such as change audio playback volume, coordinate on playlists, etc.), messaging between the multiple users, collaborating by the multiple users jointly on navigation directions, and the like. In some instances, the multiple users may use gestures, such as a swipe gesture, a pinch gesture, and a tap gesture, to indicate sharing of such content, which may allow for intuitive control of sharing between the multiple users.

As a result, various aspects of the techniques described in this disclosure may facilitate a better user experience when traveling in the vehicle while still preserving safety concerns with distracting the operator of the vehicle. As a result of permitting multiple user profiles to access the vehicle operating system, the vehicle operating system may tailor the user experience to each individual user profile allowing for preferences to be applied that are specific to each individual user profile. The vehicle operating system may also allow the multiple users to coordinate on activities (as noted above) that may improve the user experience while traveling in the vehicle. Given that the additional displays (which may be separate from a main display of the vehicle head unit) may be located in the cabin where the operator of the vehicle cannot directly see the content being presented, the vehicle operating system may permit increased permissions in terms of access to content while also potentially limiting any distractions to the operator.

In addition, various aspects of the techniques may enable the single vehicle operating system to define different user experience restrictions per occupant zone and possibly display type (e.g., virtual or physical display). Each occupant zone may be associated with an occupant zone identifier that identifies a particular occupant zone of a plurality of occupant zones (e.g., a driver occupant zone, a front passenger occupant zone, a backseat passenger occupant zone, etc.). Different user experience restrictions may be defined for each occupant zone identifier and also potentially for a display type (where passenger virtual displays, such as front passenger virtual displays that share the same underlying physical display used for the driver occupant virtual display, may receive less stringent user experience restrictions compared to, as one example, the driver occupant zone). Allowing different user experience restrictions may allow occupants (other than the driver) to safely interact with the single operating system without distracting the driver while driving (or in other operational states, such as an idle state and a parked state).

In this respect, different occupants of a vehicle may be assigned different user experience restrictions based not only on an occupant zone identifier associated with each of the multiple displays, but also potentially based on a display type (e.g., virtual display or physical display) and potentially a driving state (e.g., a parked state, an idle state, or a driving state). Incorporating these different identifiers, display types, and vehicle states may allow for granular control of presenting applications (which may be non-distraction optimized applications and distraction optimized applications) or other user interfaces via the user interface presented by the single operating system. Such granular control of user experience restrictions may allow for a better user experience depending on occupant zone, display type, and possible vehicle state and better prevent distractions to a driver of the vehicle. As such, the techniques described in this disclosure may improve the user experience for occupants of the vehicle that implements various aspects of the techniques described in this disclosure, while also potentially providing a safer operating experience for the driver by preventing distractions that may result in faulty operation of the vehicle.

In one example, this disclosure describes a method comprising: executing, by a vehicle head unit, an instance of a vehicle operating system, wherein the instance of the vehicle operating system facilitates concurrent access by multiple user profiles; authorizing, by the instance of the vehicle operating system, the multiple user profiles to interface with the instance of the vehicle operating system; presenting, by the instance of the vehicle operating system, multiple user interfaces across multiple displays communicatively coupled to the vehicle head unit, each of the multiple user interfaces associated with one or more of the multiple user profiles; and interfacing, via the multiple user interfaces, with multiple users associated with the one or more of the multiple user profiles to enable the multiple users to interface with the instance of the vehicle operating system for purposes of controlling functionality associated with the vehicle head unit.

In another example, this disclosure describes a computing device comprising: a memory configured to store an instance of a vehicle operating system, wherein the instance of the vehicle operating system facilitates concurrent access by multiple user profiles; one or more processors to execute the instance of the vehicle operating system, wherein the instance of the vehicle operating system is configured to: authorize the multiple user profiles to interface with the instance of the vehicle operating system; and present multiple user interfaces across multiple displays communicatively coupled to the vehicle head unit, each of the multiple user interfaces associated with one or more of the multiple user profiles, wherein the multiple user interfaces are configured to interface with multiple users associated with the one or more of the multiple user profiles to enable the multiple users to interface with the instance of the vehicle operating system for purposes of controlling functionality associated with the vehicle head unit.

In another example, this disclosure describes a non-transitory computer-readable storage medium having instructions stored thereon that, when executed, cause one or more processors to: execute an instance of a vehicle operating system, wherein the instance of the vehicle operating system facilitates concurrent access by multiple user profiles; authorize, via execution of the first instance of the vehicle operating system, the multiple user profiles to interface with the instance of the vehicle operating system; present, via execution of the first instance of the vehicle operating system, multiple user interfaces across multiple displays communicatively coupled to the vehicle head unit, each of the multiple user interfaces associated with one or more of the multiple user profiles; and interface, via the multiple user interfaces, with multiple users associated with the one or more of the multiple user profiles to enable the multiple users to interface with the instance of the vehicle operating system for purposes of controlling functionality associated with the vehicle head unit.

In another example, this disclosure describes a computing device comprising: means for executing an instance of a vehicle operating system, wherein the instance of the vehicle operating system facilitates concurrent access by multiple user profiles; means for authorizing the multiple user profiles to interface with the instance of the vehicle operating system; means for presenting multiple user interfaces across multiple displays communicatively coupled to the vehicle head unit, each of the multiple user interfaces associated with one or more of the multiple user profiles; and means for interfacing, via the multiple user interfaces, with multiple users associated with the one or more of the multiple user profiles to enable the multiple users to interface with the instance of the vehicle operating system for purposes of controlling functionality associated with the vehicle head unit.

In another example, this disclosure describes a method comprising: executing, by a vehicle head unit included in a vehicle, an instance of a vehicle operating system, wherein the instance of the vehicle operating system facilitates concurrent access by multiple user profiles; authorizing, by the instance of the vehicle operating system, the multiple user profiles to interface with the instance of the vehicle operating system via multiple displays communicatively coupled to the vehicle head unit; determining, based on which of the multiple displays with which each of the multiple user profiles interfaced to authorize each of the multiple user profiles, one or more occupant zone identifiers, each of the one or more occupant zone identifiers identifying an occupant zone of the vehicle in which each of the multiple user profiles are associated; obtaining, based on the one or more occupant zone identifiers, and for each of the multiple user profiles, user experience restrictions that restrict content presented via each of the multiple displays for each of the multiple user profiles; and restricting, via multiple user interfaces presented across the multiple displays by the single instance of the vehicle operating system and in accordance with the user experience restrictions, the content with which at least one of the multiple user profiles consume.

In another example, this disclosure describes a computing device comprising: a memory configured to store an instance of a vehicle operating system, wherein the instance of the vehicle operating system facilitates concurrent access by multiple user profiles; processing circuitry configured to execute the instance of the vehicle operating system, wherein the instance of the vehicle operating system is configured to: authorize the multiple user profiles to interface with the instance of the vehicle operating system via multiple displays communicatively coupled to the vehicle head unit; determine, based on which of the multiple displays with which each of the multiple user profiles interfaced to authorize each of the multiple user profiles, one or more occupant zone identifiers, each of the one or more occupant zone identifiers identifying an occupant zone of the vehicle in which each of the multiple user profiles are associated; obtain, based on the one or more occupant zone identifiers, and for each of the multiple user profiles, user experience restrictions that restrict content presented via each of the multiple displays for each of the multiple user profiles; and restrict, via multiple user interfaces presented across the multiple displays by the single instance of the vehicle operating system and in accordance with the user experience restrictions, the content with which at least one of the multiple user profiles consume.

In another example, this disclosure describes a non-transitory computer-readable storage medium having instructions stored thereon that, when executed, cause one or more processors to: execute an instance of a vehicle operating system, wherein the instance of the vehicle operating system facilitates concurrent access by multiple user profiles; authorize, via execution of the first instance of the vehicle operating system, the multiple user profiles to interface with the instance of the vehicle operating system; determine, based on which of the multiple displays with which each of the multiple user profiles interfaced to authorize each of the multiple user profiles, one or more occupant zone identifiers, each of the one or more occupant zone identifiers identifying an occupant zone of the vehicle in which each of the multiple user profiles are associated; obtain, based on the one or more occupant zone identifiers, and for each of the multiple user profiles, user experience restrictions that restrict content presented via each of the multiple displays for each of the multiple user profiles; and restrict, via multiple user interfaces presented across the multiple displays by the single instance of the vehicle operating system and in accordance with the user experience restrictions, the content with which at least one of the multiple user profiles consume.

In another example, this disclosure describes an apparatus comprising: means for executing an instance of a vehicle operating system, wherein the instance of the vehicle operating system facilitates concurrent access by multiple user profiles; means for authorizing the multiple user profiles to interface with the instance of the vehicle operating system via multiple displays communicatively coupled to the vehicle head unit; means for determining, based on which of the multiple displays with which each of the multiple user profiles interfaced to authorize each of the multiple user profiles, one or more occupant zone identifiers, each of the one or more occupant zone identifiers identifying an occupant zone of the vehicle in which each of the multiple user profiles are associated; means for obtaining, based on the one or more occupant zone identifiers, and for each of the multiple user profiles, user experience restrictions that restrict content presented via each of the multiple displays for each of the multiple user profiles; and means for restricting, via multiple user interfaces presented across the multiple displays by the single instance of the vehicle operating system and in accordance with the user experience restrictions, the content with which at least one of the multiple user profiles consume.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example computing system that is configured to provide a single-instance, multi-user vehicle operating system in accordance with various aspects of the techniques described in this disclosure.

FIG. 2 is a diagram illustrating an example of a vehicle that includes a computing system configured to execute a vehicle operating system that operates in accordance with various aspects of the single-instance multi-user techniques described in this disclosure.

FIG. 3 is a diagram illustrating different interaction models with multiple displays including interactions that occur via single instance multi-user models and multi-instance multi-user models in accordance with the vehicle operating system techniques described in this disclosure.

FIG. 4 is a diagram illustrating an example vehicle that includes a vehicle head unit configured to control audio content in accordance with various aspects of the single-instance multi-user vehicle operating system techniques described in this disclosure.

FIGS. 5 and 6 are diagrams illustrating audio control in a single-instance, multi-user vehicle operating system in accordance with various aspects of the techniques described in this disclosure.

FIG. 7 is a flowchart illustrating example operation of the computing system shown in FIG. 1 in executing a vehicle operating system configured to perform various aspects of the techniques described in this disclosure.

FIG. 8 is a block diagram illustrating the VOS shown in FIG. 1 in providing multi-user experience restrictions according to various aspects of the techniques described in this disclosure.

### DETAILED DESCRIPTION

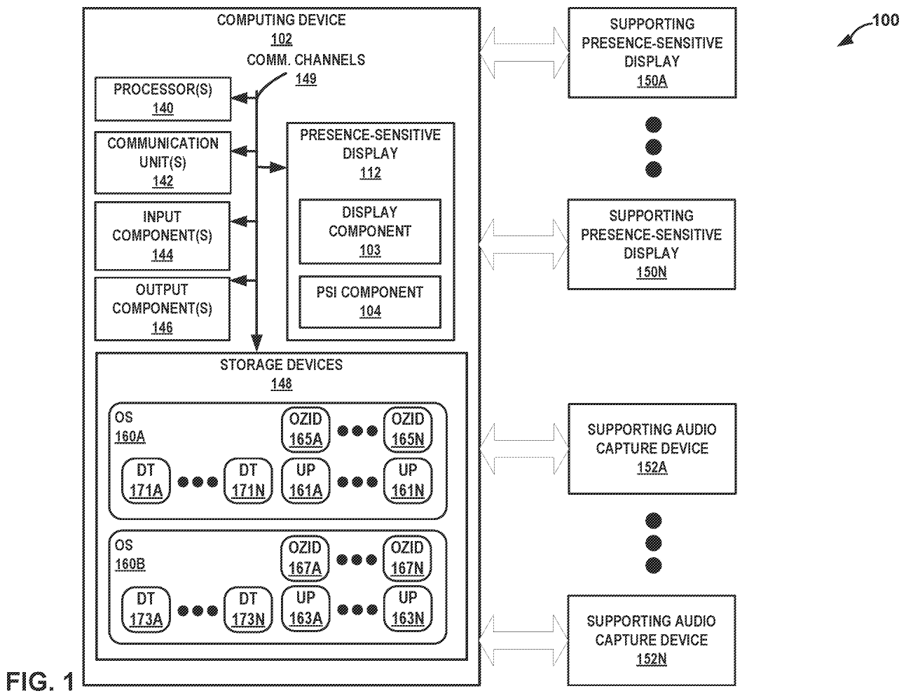

FIG. 1 is a block diagram illustrating an example computing system that is configured to provide a single-instance, multi-user vehicle operating system in accordance with various aspects of the techniques described in this disclosure. As shown in the example of FIG. 1, a computing system 100 includes a computing device 102. Although described with respect to a vehicle, the computing system 100 may be utilized in different contexts, including standalone computing systems (including laptop computers, desktop computers, workstations and the like), gaming systems, cellular telephones (including so-called “smartphones”), media systems (including streaming media systems), audio/visual (A/V) receivers, televisions (including so-called “smart televisions”), smart speakers, smart watches, thermostats (including so-called “smart thermostats”), smart glasses, or any other computing system.

In any event, computing device 102 is an example of vehicle computing device, such as a vehicle head unit. FIG. 1 illustrates only one particular example of computing device 102, and many other examples of computing device 102 may be used in other instances and may include a subset of the components included in example computing device 102 or may include additional components not shown in FIG. 1.

As further shown in the example of FIG. 1, computing device 102 includes presence-sensitive display 112, one or more processors 140, one or more communication units 142, one or more input components 144, one or more output components 146, and one or more storage devices 148, and communication channels 149. Communication channels 149 may interconnect each of the components 112, 140, 142, 146, and/or 148 for inter-component communications (physically, communicatively, and/or operatively) and thereby allow components 112, 140, 142, 146, and 148 to communicate with one another. In some examples, communication channels 149 may include a system bus, a network connection, one or more inter-process communication data structures, or any other components for communicating data (also referred to as information). Although shown as including components 112, 140, 142, 146, and 148, computing device 102 (which may be referred to as “main computing device 102”) may include other components or less components than those shown, where such components may be included in other control units such as a telematic control unit (TCU).

One or more communication units 142 of computing device 102 may communicate with external devices by transmitting and/or receiving data. For example, computing device 102 may use one or more of communication units 142 to transmit and/or receive radio signals on a radio network such as a cellular radio network. In some examples, communication units 142 may transmit and/or receive satellite signals on a satellite network such as a Global Positioning System (GPS) network. Examples of communication units 142 include a network interface card (e.g. an Ethernet card), an optical transceiver, a radio frequency transceiver, a GPS receiver, or any other type of device that can send and/or receive information. Other examples of communication units 142 may include a controller area network (CAN—operating via CAN bus), short wave radios (e.g., NFC, BLUETOOTH (including BLE)), GPS, 3G, 4G, 5G, and WIFI radios found in mobile devices as well as Universal Serial Bus (USB) controllers and the like.

One or more input components 144 of computing device 102 may receive input. Examples of input are tactile, audio, kinetic, and optical input, to name only a few examples. Input components 144 of computing device 102 include, in one example, a mouse, keyboard, touchpad, voice responsive system, video camera, buttons, scroll wheel, dial, control pad, a microphone (or, in other words, an audio capture device), or any other type of device for detecting input from a human or machine. Input components 144 may include cameras. In some examples, input component 144 may be a presence-sensitive input component, which may include a presence-sensitive screen, touch-sensitive screen, etc. separate from presence-sensitive display 112.

One or more output components 146 of computing device 102 may generate output. Examples of output are tactile, audio, and video output. Output components 146 of computing device 102, in some examples, include a presence-sensitive screen (possibly separate from presence-sensitive display 112), a sound card, a video graphics adapter card, a speaker, a liquid crystal display (LCD), organic light emitting diode (OLED), or any other type of device for generating tactile, audio and/or visual output to a human or machine.

In some examples, presence-sensitive display 112 of computing device 102 may include functionality of input component 144 and/or output components 146. In the example of FIG. 1, presence-sensitive display 112 may include a presence-sensitive input (PSI) component 104 (“PSI component 104”), such as a presence-sensitive screen or touch-sensitive screen. In some examples, presence-sensitive input component 104 may detect an object at and/or near the presence-sensitive input component. As one example range, presence-sensitive input component 104 may detect an object, such as a finger or stylus that is within two inches or less of presence-sensitive input component 104. Presence-sensitive input component 104 may determine a location (e.g., an (x, y) coordinate) of the presence-sensitive input component at which the object was detected. In another example range, presence-sensitive input component 104 may detect an object two inches or less from presence-sensitive input component 104 and other ranges are also possible. Presence-sensitive input component 104 may determine the location of presence-sensitive input component 104 selected by a user's finger using capacitive, inductive, and/or optical recognition techniques.

In some examples, presence-sensitive display 112 may also provide output to a user using tactile, audio, or video stimuli as described with respect to output component 146. For instance, presence-sensitive display 112 may include display component 103 that displays a graphical user interface. Display component 103 may be any type of output component that provides visual output, such as described with respect to output components 146. While illustrated as an integrated component of computing device 102, presence-sensitive display 112 may, in some examples, be an external component that shares a data or information path with other components of computing device 102 for transmitting and/or receiving input and output. For instance, presence-sensitive display 112 may be a built-in component of computing device 102 located within and physically connected to the external packaging of computing device 102 (e.g., an in-vehicle screen mounted in a dashboard of a vehicle). In another example, presence-sensitive display 112 may be an external component of computing device 102 located outside and physically separated from the packaging of computing device 102 (e.g., a monitor, a projector, etc. that shares a wired and/or wireless data path with an electronic control unit of the vehicle). In some examples, presence-sensitive display 112, when located outside of and physically separated from the packaging of computing device 102, may be implemented by two separate components: a presence-sensitive input component 104 for receiving input and a display component 103 for providing output.

One or more storage devices 148 within computing device 102 may store information for processing during operation of computing device 102 (e.g., computing device 102 may store data accessed by operating system (OS) 160A and OS 160B during execution at computing device 102). As shown in the example of FIG. 1, one or more storage devices 148 may store a first instance of an operating system 160A (OS 160A) and a second instance of operating system 160B (OS 160B). In some examples, storage component 148 is a temporary memory, meaning that a primary purpose of storage component 148 is not long-term storage. Storage devices 148 of computing device 102 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage devices 148, in some examples, also include one or more computer-readable storage media. Storage devices 148 in some examples include one or more non-transitory computer-readable storage mediums. Storage devices 148 may be configured to store larger amounts of information than typically stored by volatile memory. Storage devices 148 may further be configured for long-term storage of information as non-volatile memory space and retain information after power on/off cycles. Examples of non-volatile memories include magnetic hard discs, optical discs, flash memories, or forms of electrically programmable memories (EPROM) or electrically erasable and programmable (EEPROM) memories.

Storage devices 148 may store program instructions and/or information (e.g., data) associated with OS 160A and/or 160B. Storage devices 148 may include a memory configured to store data or other information (which is not shown for ease of illustration purposes) associated with OS 160A and OS 160B.

One or more processors 140 may implement functionality and/or execute instructions associated with computing device 102. Examples of processors 140 include application processors, display controllers, auxiliary processors, one or more sensor hubs, and any other hardware configure to function as a processor, a processing unit, a processing device, a controller area network (CAN-operating via a CAN bus), or other processing circuitry. OS 160A and/or 160B may be operable (or, in other words, executed) by processors 140 to perform various actions, operations, or functions of computing device 102.

That is, OS 160A and/or OS 160B may form executable bytecode, which when executed, cause processors 140 to perform specific operations (and thereby causing computing device 102 to become a specific-purpose computer by which to perform) in accordance with various aspects of the techniques described herein. For example, processors 140 of computing device 102 may retrieve and execute instructions stored by storage devices 148 that cause processors 140 to perform the operations described herein that are attributed to OS 160A and/or 160B. The instructions, when executed by processors 140, may cause computing device 102 to store information within storage devices 148.

As described above, computing system 100 may be integrated or otherwise included within a vehicle. The vehicle may include one or more of a bicycle, a tricycle, a unicycle, a motorcycle, an automobile, farm equipment (such as a tractor, combine, etc.), construction equipment (a dump truck, crane, etc.), military vehicle or equipment (a tank, armament, etc.), a truck, a semi-tractor (or, in other words, a semi-trailer), aviation equipment (such as an airplane), nautical equipment (such as a boat, carrier, submarine, etc.), or any other type of vehicle.

Computing device 102 (which may be, as noted above, referred to as vehicle head unit 102 and also as an infotainment system 102) may be configured to execute a vehicle operating system, such as one or more of OS 160A and 160B (which as a result may also be referred to as vehicle OS 160A—VOS 160A—and VOS 160B), to facilitate control of, to provide a few examples, entertainment (such as music, video, images, etc.), information, navigation, and voice calls, as well as vehicle systems, such as heating, ventilation, and air conditioning (HVAC) systems, lighting systems, and seat control systems (including heating and/or cooling, seat adjustment, etc.). In some instances, vehicle operating systems may allow a single user profile to access a given instance of the vehicle operating system at once, where the single user profile is typically the operator of the vehicle.

This vehicle operating system may be referred to as a single-instance, single-user vehicle operating system, That is, a single instance of the vehicle operating system may only allow a single user profile to access the single instance of the vehicle operating system and require a user profile switch in which the single user profile is replaced with another single user profile. In this respect, only a single user profile can access a single instance of the vehicle operating system at any given time.

To enable multiple concurrent user profiles, processors 140 may execute another instance of the vehicle operating system, which may require additional processors and/or higher processing capacity processors (which are typically more expensive). However, there may be difficulties in enabling efficient communication between both instances of the vehicle operating system such that users associated with the multiple user profiles are unable to share content between one another, thereby potentially limiting the user experience.

As such, while the instance of the vehicle operating system may support multiple user profiles, the instance of the vehicle operating system may only allow a single user profile of the multiple user profiles to access (or in other words “log into”) the instance of the vehicle operating system. The instance of the vehicle operating system may limit access to a single user profile to ensure that the operator of the vehicle does not become distracted by other user profile behavior while operating the vehicle.

Furthermore, the instance of the vehicle operating system may restrict content for a variety of reasons including safety to prevent driver distraction (e.g., based on an operational state of the vehicle, such as driving, idle, and parked), privacy and security (e.g., by way of user profile restrictions that may include age-based limits, content-type limits, personal information security, etc.), and the like. By allowing only a single user profile of the multiple user profiles to access the instance of the vehicle operating systems, the instance of the vehicle operating system may restrict content of other occupants of the vehicle interfacing with one or more displays that may or may not introduce distractions while operating the vehicle (e.g., a rear seat passenger display may be restricted unnecessarily to restrictions configured for the single user profile that is often associated with the driver rather than the rear seat passenger). These potentially unnecessary restrictions may degrade the user experience provided to other occupants that are not actively operating the vehicle, and thereby potentially unnecessarily impact the user experience provided by the single instance of the vehicle operating system.

The foregoing restrictions may be considered less granular in the sense that such restrictions apply only to the single user profile that is currently authorized to interact with the vehicle operating system rather than applying unique restrictions based on which display with which each of the multiple user profiles may interface. As vehicles begin to incorporate larger displays, a single physical display may present two or more virtual displays (e.g., a single physical dashboard display for front passengers may include two or more virtual displays—one or more for the front driver or, in other words, operator occupant zone, and one or more virtual displays for a front passenger occupant zone).

The single instance of the vehicle operating system may provide restrictions for the single user profile that may only be defined based on physical display port numbers, which would apply to the single physical dashboard display despite the display spanning multiple occupant zones and presenting multiple virtual displays. Such restrictions are therefore even less granular as the restrictions do not allow for virtual displays, which may further degrade the user experience (e.g., given that the front passenger may be restricted to whatever restrictions are provided for the front operator occupant zone despite that presentation of content in the front passenger occupant zone may not present sufficient distractions for the operator of the vehicle to warrant such restrictions).

In accordance with various aspects of the techniques described in this disclosure, computing system 100 may implement a single instance of a vehicle operating system, such as VOS 160A and/or 160B (“VOS 160”), that provides concurrent multi-user support. Rather than limit access to a single user profile for the single instance of VOS 160, a single instance of the VOS 160 described in this disclosure may allow multiple user profiles to access the single instance of VOS 160. As vehicles have begun integrating increasingly more displays, such as supporting presence-sensitive displays 150A-150N (“supporting presence-sensitive displays 150,” which may also be referred to as “displays 150”) in a cabin of the vehicle, more users may safely interface with VOS 160 without distracting an operator of the vehicle (considering that in some examples, the operator either has limited view of these displays 150 or has no direct view of these displays 150, which may be disposed behind the operator for rear seat passengers). As such, multiple users associated with multiple user profiles may access VOS 160 and interact with computing device 102 to control various functionality provided via computing device 102, such as entertainment, information, navigation, and voice calls as well as various vehicle systems (which may be, to some extent, dependent on the multiple user locations within the vehicle).

The multiple users may also interface with VOS 160 to jointly coordinate activities among the multiple users, such as sharing content between the multiple users, reviewing content viewed by other users of the multiple users, control audio playback between the multiple users (such as change audio playback volume, coordinate on playlists, etc.), messaging between the multiple users, collaborating by the multiple users jointly on navigation directions, and the like. In some instances, the multiple users may use gestures, such as a swipe gesture, a pinch gesture, and a tap gesture, to indicate sharing of such content, which may allow for intuitive control of sharing between the multiple users.

In operation, computing device 102 may, as shown in the example of FIG. 1, interface with displays 150, which may be similar to if not substantially similar to presence-sensitive display 112. However, rather than integrate into computing device 102 similar to presence-sensitive display 112, displays 150 may be communicatively coupled (via wire or wirelessly) to computing device 102 and integrated throughout the cabin of the vehicle or separate from the vehicle. That is, displays 150 may also, in some instances, represent tablets, smartphones, laptops, portable gaming device, portable video devices, or any other device capable of interfacing with computing device 102 to present a user interface associated with VOS 160 (and/or applications executing in an application space presented by VOS 160, which may be separate from a privileged kemel space in which VOS 160 executes to facilitate interactions between the applications and underlying hardware, such as units 112, and 140-148).

In any event, processors 140 may execute an instance of a vehicle operating system, such as VOS 160A or VOS 160B, wherein VOS 160A and/or 160B facilitates concurrent access by multiple user profiles that are shown in the example of FIG. 1 as user profiles (UP) 161A-161N (“UP 161”) for VOS 160A and UP 163A-163N (“UP 163”) for VOS 160B. UP 161/163 may each define a set of access rights (or in other words privileges), preferences (e.g., for user interfaces, VOS 160 settings, etc.), and other user-specific configuration data or information. UP 161/163 may each be associated with a different user, although UP 161 and UP 163 may include user profiles for the same user. For example, UP 161A and UP 163A may be associated with the same user.

Processors 140 may execute, as one example, VOS 160A and authorize multiple user profiles of UP 161 to interface with VOS 160A. To authorize multiple user profiles of UP 161, each of the users may register with VOS 160A, entering a username (associated with a given one of UP 161) and a password to log into VOS 160A. Alternatively, any other way by which to log into VOS 160A may be enabled, such as scanning a quick response (QR) code with a camera of a smartphone, entering a personal identification number (PIN), performing a biometric process (e.g., a fingerprint scan, a retina scan, etc.), facial recognition or any other way by which to register a given user profile of Ups 161 with VOS 160A. OS 160A may compare the entered information with authentication information stored to UP 161 to authorize (or in other words authenticate) each of the multiple user profiles of UP 161 to interface with VOS 160A.

While discussed with respect to authentication, VOS 160A may also allow guest user profiles (as one of UP 161) in which authorization is provided without requiring any authentication. In this respect, guest user profiles may provide a limited experience (compared to authenticated UP 161) in terms of maintaining preferences, applications, etc. across different sessions but still enable functionality described below with respect to sharing content between multiple UP 161 and the like.

In any event, VOS 160A may present multiple user interfaces across multiple displays (such as display 112 and one or more of displays 150) communicatively coupled to computing device 102. VOS 160A may, for authenticated UP of UP 161, present the user interface specific for each of the authenticated UP that maintains preference in terms of application organization, user interface theme, various VOS 160A settings (e.g., regarding notifications, accessibility, display configuration in terms of brightness, resolution, orientation, and the like, and any other type of OS setting). In any event, each of the multiple user interfaces are associated with one or more of UP 161.

VOS 160A may next interface, via the multiple user interfaces, with multiple users associated with multiple UP of UP 161 to enable the multiple users to interface with VOS 160A for purposes of controlling functionality associated with computing device 102. This functionality may include controlling navigation, changing content playback, changing user interface settings, controlling HVAC settings, sharing content between UP 161, and other functionality described below in more detail.

In some examples, processors 140 may represent a high processing capacity processor (which may be referred to as “processor 140A”) and a low processing capacity processor (which may be referred to as “processor 140B”). In some instances, processor 140 may represent a processor capable of variable processing capacity having two or more distinct operating voltages that enable, at high voltages, high processing capacity and, at low voltages, low processing capacity. In this sense a single processor may represent both processor 140A and processor 140B, switching between the different processing modes (e.g., high and low processing modes) to facilitate power conservation. Processor 140A may provide additional processor cores compared to processor 140B (or in the instance where a single processor switches between processing mode, enable additional cores in the high processing mode when compared to the low processing mode).

Processor 140A may execute VOS 160A, while processor 140B may execute VOS 160B. Processor 140A may execute VOS 160A for tasks that require higher processing, such as gaming, video conferencing, navigation, and other processor intensive tasks/applications. Processor 140B may execute VOS 160B for tasks that require lower processing, such as streaming audio, telephone calls, viewing images, text messaging, or other less processor intensive tasks/applications.

In some examples, processor 140A may execute VOS 160A concurrent to processor 140B executing VOS 160B. In instances of concurrent execution of VOS 160A and 160B, VOS 160A may present an interface by which VOS 160B may communicate with VOS 160A to facilitate various functionalities of computing device 102. This interface may represent an application programming interface that VOS 160B may invoke to facilitate inter-VOS communication between VOS 160A and VOS 160B to cooperatively facilitate support to functionality provided by computing device 102.

Utilizing different processing capacity processors may facilitate energy consumption. Further, it may be cost prohibitive to install high processing capacity processor 140 capable of all of the functionality supported by computing device 102, where a low processing capacity processor 140 may allow the manufacturer to upgrade over time to add additional processors having high processing capacity (and/or possibly low processing capacity). Providing a framework for inter-VOS communication may allow for manufacturers to upgrade over time without having to configure a separate inter-VOS communication interface by which to facilitate access to the functionality of computing device 102 described in more detail below.

As further shown in the example of FIG. 1, computing device 102 may also interface with supporting audio capture devices 152A-152N (“supporting audio capture devices 152” or “audio capture devices 152”). Audio capture devices 152 may each represent a microphone or other transducer configured to capture audio data representative of a soundfield. Supporting audio capture devices 152 may also be referred to as “microphones 152.” In some examples, audio capture devices 152 may be integrated throughout one or more zones of the cabin of the vehicle that includes computing device 102. These zones may include an operator zone, one or more front passenger zones, and one or more rear passenger zones. As described below in more detail, these microphones 152 may capture (or, in other words, record, detect or otherwise sense) audio data that VOS 160 may use to adjust audio playback as well as support additional functionality provided by computing device 102.

In this way, various aspects of the techniques may facilitate a better user experience when traveling in the vehicle while still preserving safety concerns with distracting the operator of the vehicle. As a result of permitting multiple UP 161/163 to access VOS 160A/160B, VOS 160A/160B may tailor the user experience to each individual UP of UP 161/163 allowing for preferences to be applied that are specific to each individual UP. VOS 160A/160B system may also allow the multiple users to coordinate on activities (as noted above) that may improve the user experience while traveling in the vehicle. Given that additional displays 150 (which may be separate from a main display, e.g., presence-sensitive display 112, of vehicle head unit 102) may be located in the cabin where the operator of the vehicle cannot directly see the content being presented, VOS 160A/160B may permit increased permissions in terms of access to content while also potentially limiting any distractions to the operator.

In addition, various aspects of the techniques may enable VOS 160 to define different user experience restrictions per occupant zone (OZ) and possibly display type (DT, e.g., virtual or physical display type). Each occupant zone may be associated with an occupant zone identifier (OZID) 165A-165N (“OZID 165”) and/or OZID 167A-167N (“OZID 167”) that identifies a particular occupant zone of a plurality of occupant zones (e.g., a driver occupant zone, a front passenger occupant zone, a backseat passenger occupant zone, etc.). VOS 160 may define different user experience restrictions for each occupant zone identifier and also potentially for a display type 171A-17IN and/or display type 173A-173N (“DT 171/173,” where passenger virtual displays, such as front passenger virtual displays that share the same underlying physical display used for the driver occupant virtual display, may receive less stringent user experience restrictions compared to, as one example, the driver occupant zone). Allowing different user experience restrictions may allow occupants (other than the driver) to safely interact with the single operating system without distracting the driver while driving (or in other operational states of the vehicle, such as an idle state and a parked state).

In operation, VOS 160 may determine, based on which of multiple displays (such as display component 103, additional displays 150, etc.) with which each of UP 161/163 interfaced to authorize each of UP 161/163, one or more of OZIDs 165/167. Each of OZIDs 165/167 may identify an occupant zone of the vehicle in which each of the UP 161/163 are associated. As such, each of UP 161/163 are associated with one or more OZIDs 165/167, which may allow VOS 160 to obtain user experience (UX) restrictions (UXR) that are specific to a given occupant zone of the vehicle. That is, VOS 160 may maintain a UXR mapping that defines assignment of UXR to each of UP 161/163 based on OZID 165/167. When attempting to authorize one or more of UP 161/163, VOS 160 may register within the UXR mapping each of the one or more UP 161/163 to a given OZID 165/167 along with possibly DT 171/173. VOS 160 may assign the UXR per application executed by VOS 160 and updated based on the operational state of the vehicle, as described in more detail below.

VOS 160 may next restrict, via multiple user interfaces presented across the multiple displays (e.g., display component 103, additional displays 150, etc.) and in accordance with the UXR defined for each of UP 161/163, the content with which at least one of UP 161/163 consume. As a result, VOS 160 may tailor UXR for the specific UP 161/163 based on the location of the display (possibly whether virtual or physical as defined by DT 171/173) within the vehicle (as defined by OZID 165/167) that may adapt to the operational state of the vehicle to potentially maintain safety (through limiting distractions for the operator of the vehicle) while also possibly improving the user experience for other occupants of the vehicle that are not operating the vehicle.

In this respect, different occupants of the vehicle may be assigned different user experience restrictions (as represented by UP 161/163) based not only on OZID 165/167 associated with each of the multiple displays, but also potentially based on a display type (e.g., virtual display or physical display) and a driving state (e.g., a parked state, an idle state, or a driving state). Incorporating these different identifiers, display types, and vehicle states may allow for granular control of presenting applications (which may be non-distraction optimized applications and distraction optimized applications) or other user interfaces via the user interface presented by the single operating system. Such granular control of user experience restrictions may allow for a better user experience depending on occupant zone, display type, and possible vehicle state and better prevent distractions to a driver of the vehicle. As such, the techniques described in this disclosure may improve the user experience for occupants of the vehicle that implements various aspects of the techniques described in this disclosure, while also potentially providing a safer operating experience for the driver by preventing distractions that may result in faulty operation of the vehicle.

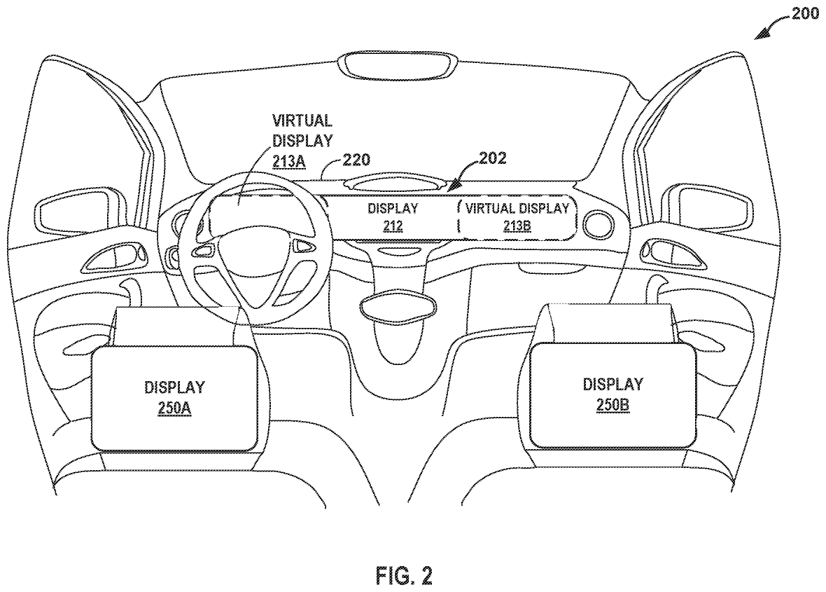

FIG. 2 is a diagram illustrating an example of a vehicle that includes a computing system configured to execute a vehicle operating system that operates in accordance with various aspects of the single-instance multi-user techniques described in this disclosure. As shown in the example of FIG. 2, an interior (which may be referred to as a “cabin”) of vehicle 200 may include a computing system in the form of vehicle head unit 202, which represents an example of computing device 102.

Vehicle head unit 202 is, in the example of FIG. 2, integrated into approximately a center portion (e.g., a center console) of a front dashboard 220. Vehicle head unit 202 includes a display 212, which may represent one example of presence-sensitive display 112. Display 212 may be displaced in a front dash 220 of vehicle 200. Display 212 may represent a single physical display that supports presentation of multiple virtual displays 213A and 213B. Display 212 may present virtual display 213A in the driver occupant zone and virtual display 213B in a front passenger occupant zone.

Vehicle 200 may also include (in this example, physical) displays 250A and 250B, which may represent examples of displays 150 described above with respect to FIG. 1. Displays 250A and 250B are integrated into a rear passenger compartment of the cabin (i.e., in headrests of the front seats in the example of FIG. 2) on both the operator side (display 250A) and a passenger side (display 250B). Although described a physical displays 250A and 250B in the example of FIG. 2, displays 250A and/or 250B may represent virtual displays.

As described above, VOS 160A may interface, via a first user interface (presented for example by virtual display 213B) associated with a first user profile (e.g., UP 161A), with a first user (a front passenger) to interact with content presented by a second user interface (e.g., presented for example by display 250B) associated with a second user profile (e.g., UP 161B) of multiple UP 161. In some instances, VOS 160A may interfacing with the first user to one or more of view or initiate playback, at the first user interface, the content presented by the second user interface.

VOS 160A may also interface with the first user to control audio playback by the second user interface presented by display 250B. VOS 160A may interface with the first user to, via the first user interface presented by display 213B, change an audio volume associated with the audio playback by the second user interface presented by display 250B.

VOS 160A may also interface with the first user to enable the first user and the second user (e.g., an operator-side rear passenger) to jointly interact with the content presented by the second user interface presented by display 250B. In this example, VOS 160A may interface with the first user to enable the first user and the second user to jointly contribute to audio playback by the second user interface (such as by jointly collaborating on building an audio playlist). VOS 160A may also, as another example, interface with the first user to enable the first user and the second user to jointly contribute to a multi-user activity presented by the second user interface, where such multi-user activity may include a navigation activity in which both the first user and the second user contribute to navigation of vehicle 200 that includes vehicle head unit 202 and/or a multi-player video game presented by the second user interface.

While shown as multiple physical displays 212/250, various aspects of the techniques may operate with respect to a single physical display (or multiple physical displays) having separate logically separated displays (or so-called virtual displays 213A and/or 213B). That is, a single physical display 212/250 may be logically split (e.g., via software) to represent two distinct physical displays (from the perspective of the instance of VOS 160). In this respect, a single physical display may represent multiple different displays and displays 212/250 may each represent a logically separate virtual display.

In this respect, various aspects of the techniques described herein may enable a number of different use cases, including the following:
A parent would like to see what their children are watching;
Parent or driver would like to control the volume from the children's displays;
Two or more passengers may want to contribute to some shared playlist; and
Two or more passengers may want to interact on the same content (like a multi-game player).
   The following use cases may be enabled given that the techniques allow for the following:
Mirror displays contents when running on Android Auto;
Allow drivers and passengers mirror their display contents; and
Let driver or passenger send inputs, like (key, rotary, dpad, touch, etc events) to other's passenger displays.

In other words, various aspects of the techniques described herein may address problems associated with enabling mobile apps to interact with each other (same or different app) across concurrent multiple users on single Android instance. As such, the techniques may enable interaction from rear seat to operator for adding a stop in navigation and/or interaction from an operator to rear seat (such as a child) for playing video.

VOS 160A may also interface, via the first user interface associated with UP 161A, with a first user (front passenger) of the multiple users to share content presented by the first user interface with a second user interface of the multiple user interfaces associated with UP 161B. For example, VOS 160A may receive, at the first user interface presented as an example by display 213A, a gesture that indicates the content presented by the first user interface is to be shared with the second user interface presented for example by display 250B. The gesture may include one or more of a swipe gesture, a pinch gesture, a tap gesture, or any other gesture associated with using presence-sensitive displays, such as display 213A.

VOS 160A may be configured to, in some instances, present, at the first user interface, an animation indicating initiation of the content being shared. In addition or alternatively, VOS 160A may play audio indicating initiation of the content being shared. In some examples, VOS 160A may, when playing audio indicating initiation of the content being shared, play spatialized audio to reflect a position of the first user interface relative to a position of the second user interface.

In this respect, various aspects of the techniques may make cross-display interaction, such as sharing screens, more immersive using advanced user interface technologies. Based on the locational relationship between passenger zones in the vehicle, the techniques may enable the following:
Sending content from one display to another using gesture (swipe, click, etc.);
Visualizing the interaction using animation; and
Using spatial audio to show where the content is moving to make it more immersive.

Moreover, VOS 160A may determine, based on which UP 161/163 was used to authenticate or otherwise authorize interaction with VOS 160A via one or more of displays (virtual displays 213A and/or 213B—“virtual displays 213” and/or displays 250A and/or 250B, which may be referred to as “physical displays 250”), one or more OZIDs 165/167. VOS 160A may assign virtual display 213A OZID 165A (as an example) that contains a value of zero (0) identifying the driver occupant zone, virtual display 213B OZID 165B (as another example) that contains a value of one (1) identifying the front passenger occupant zone, etc.

VOS 160A may, in some instances, also identify a display type 171/173 that indicates (possibly as a Boolean) whether each of displays for which authorization was provided to UP 161/163 to access VOS 160A is either a physical display or a virtual display (or in other words, is a virtual display 213 that is presented by at least one physical display 212). VOS 160A may utilize OZID 165/167 along with DT 171/173 to differentiate between virtual displays 213 presented via a same physical display 212 in order to appropriately assign UXR to UP 161/163. VOS 160A may also utilize OZID 165/167 along with possibly DT 171/173 to differentiate between display 212, virtual displays 213, and physical displays 250, assigning UXR to UP 161/163 based on one or more of OZID 165/157 and DT 171/173.

VOS 160A may further determining UXR based on a type of application executed by VOS 160A and then presented via each one of displays 212, 213, and/or 250. That is, in some instances, various applications executed with the application space presented by VOS 160A may be distraction optimized (“DO,” meaning such applications are optimized to reduce distractions and thereby may executed with more limiting UXR compared to non-DO applications). For example, DO applications (which may be optimized for vehicle computing systems, such as vehicle head unit 202) may restrict the type of content presented or may improve upon the interface to facilitate less distractions compared to non-DO applications (which may be optimized for other computing platforms, such as laptop computers, smartphones, gaming systems, smart glasses, augmented/virtual/mixed reality systems, smartwatches, etc.). VOS 160A may allow DO applications to executed in limited UXR while limiting or preventing execution of non-DO applications in the same limited UXR.

VOS 160A may also determine an operating state of vehicle 200 (potentially via VOS 160B). The operating state of vehicle 200 may refer to various operating conditions in which VOS 160A may present various interfaces via displays 212/213/250. Such operating conditions may for example include a driving state, an idle state, a parked state, etc. VOS 160A may register each UP 161/163 via an API, providing OZID 165/167 determined for each UP 161/163 along with possibly DT 171/173. Upon registering each UP 161/163, VOS 160A may monitor application types being executed for each UP 161/163 along with the operational state of vehicle 200, updating UXR responsive to changes in application types and the operational state of vehicle 200.

VOS 160A may continually or periodically update UXR assigned to each UP 161/163 depending on changes to the operating state and/or application type. VOS 160A may assign different UXR, as one example, based on the driving state, the idle state, and the parked state, UXR for the driving state may be more limiting than UXR for the idle state (as distractions during the idle state represent less of a safety concern compared to the driving state), while UXR for the idle state may be more limiting than UXR for the parked state (where again distractions during the parked state represent less of a safety concern compared to the idle state).

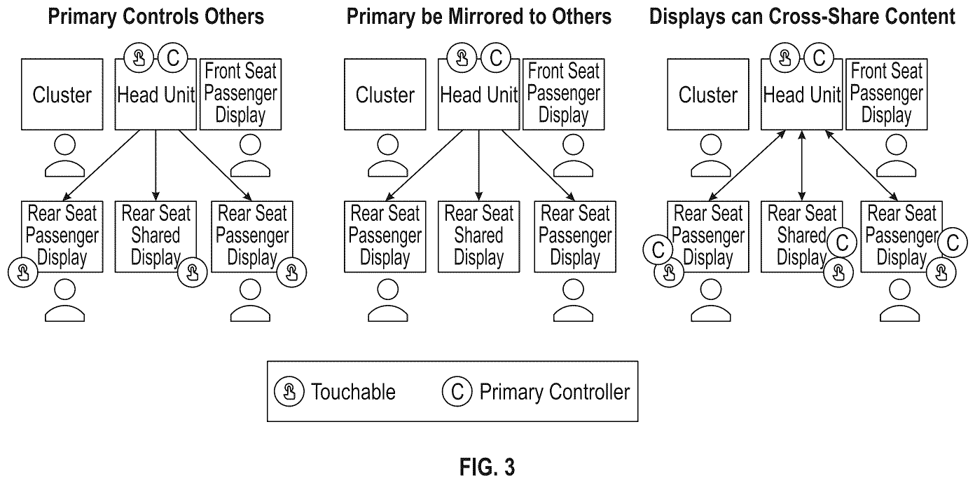

FIG. 3 is a diagram illustrating different interaction models with multiple displays including interactions that occur via single instance multi-user models and multi-instance multi-user models in accordance with the vehicle operating system techniques described in this disclosure. As discussed in this disclosure, vehicle displays, such as displays 212 and 250, are evolving from operator centric to whole car experiences, where passengers can have the following:
Personal curated experiences while commuting to work;
Communal experiences to enjoy a family fun trip; and
Shared experiences, while in an ride-sharing environment

Original equipment manufacturers (OEMs) may recognize these needs and are building cars to provide users with these experiences. These are no more seen as premium experiences but a value for a desirable vehicle.

In this respect, users may look for concurrent experiences across displays for a seamless and immersive experience, such as:
Navigation—add stops to driver from their display for ongoing journey;
Entertainment—Play and control video for kids in backseat or play games to keep them engaged & entertained;
Users—Access their own curated apps, content and data for entertainment and/or productivity; and
Personalization—Control my seat settings, HVAC control, alerts for my seat.

OEMs are thinking about following user interaction models, based on anticipation of user behaviors. There are 3 types of interactions models (shown in the example of FIG. 3):
1. In-vehicle infotainment (IVI) Display is the primary controller for content on front seat entertainment (FSE) and rear seat entertainment (RSE);
   a. FSE and RSE have minimal controls—audio, play/pause, on/off etc.
2. IVI Screen is mirrored across FSE/RSE, with passenger displays cannot select content or controls; and
3. Content can be shared across all the screens, with each screen having its own individual controls.

There are the following user personas for multi-display scenarios:
Driver:
   Interacting with cluster & IVI screens for driving and interacting with other screens in car
Front seat passenger:
   Assisting to driver for navigation and passengers content using FSE
Rear seat passengers:
   Interacting with RSE for content, controls and suggestions to driver for navigation
Guest:
   Temporary riding in the car and wants to access some apps on passenger displays

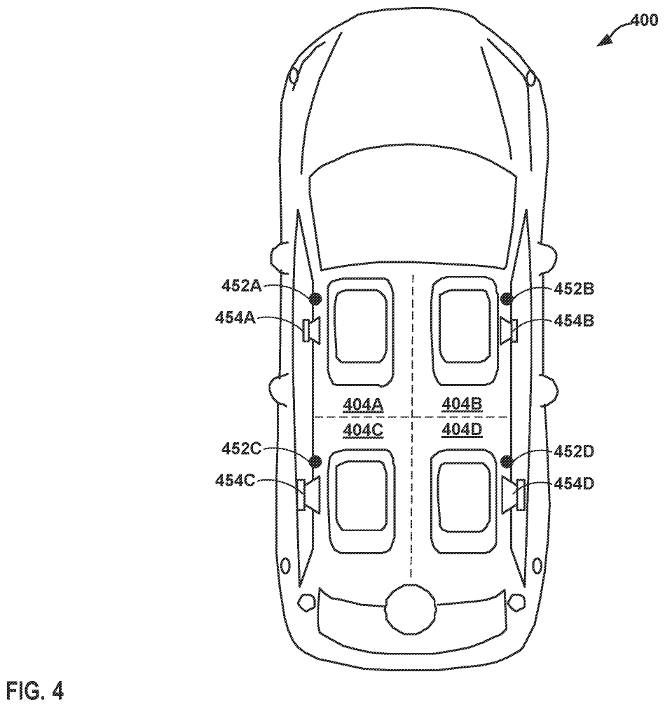

FIG. 4 is a diagram illustrating an example vehicle that includes a vehicle head unit configured to control audio content in accordance with various aspects of the single-instance multi-user vehicle operating system techniques described in this disclosure. In the example of FIG. 4, a vehicle 400 may represent an example of vehicle 200 (shown in FIG. 2) in which a vehicle head unit 202 may enable privacy and sharing between different audio zones 404A-404D (“audio zones 404”) within vehicle 400. Audio zone 404A may represent a front seat operator-side zone (also denoted a “front operator zone 404A”). Audio zone 404B may represent a front seat passenger-side zone (also denoted a “front passenger zone 404B”). Audio zone 404C may represent an operator-side rear passenger zone, while audio zone 404D may represent a passenger-side rear passenger zone.

In each of audio zones 404, vehicle 200 may include a respective one of audio capture devices 452A-452D (“audio capture devices 452”) and a respective one of speakers 454A-454D (“speakers 454”), Audio capture devices 452 may represent examples of audio capture devices 152. Both audio capture devices 452 and speakers 454 may represent transducers capable of converting, in the instance of audio capture devices 452, sound pressure into electrical signals representative of a soundfield and, in the instance of speakers 454, electrical signals representative of a soundfield into the corresponding soundfield.

Although described as having a single one of audio capture devices 452 and a single one of speakers 454 in each of audio zones 404, each of audio zones 404 may include more or less audio capture devices 452 and more or less speakers 454. Further, while described as being transducers, any type of device capable of capturing audio data (transformed from the electrical signals captured by the audio capture devices 452) and reproducing a soundfield from electrical signals (transformed from audio data) may be utilized in one or more of audio zones 404. In addition, while four audio zones 404 are shown in the example of FIG. 4, vehicle 400 may include more or less audio zones 404.

In any event, VOS 160A may interface with the multiple users to control audio playback within one or more of zones 404 of a cabin of vehicle 400 that includes vehicle head unit 202. VOS 160A may, for example, interface with the multiple users to control audio volume in a single one of zones 404 of the cabin. As another example, VOS 160A may interface with the multiple users to control a focus of audio playback in at least one of zones 404 of the cabin.

As such, various aspects of the techniques may provide a central service for audio controls concurrently for all users (e.g., driver and/or passengers) to control audio settings (volume up/down, mute, unmute, or any other control). To facilitate this control, VOS 160A may provide a service to manage audio controls (e.g., volume, mute, settings, ducking, interruptions, etc.) so as to provide the following:
Manage controls independently for each user in their respective audio zones;
Manage focus for other users in separate zone;
While taking into consideration current safety restrictions; and
While taking into consideration current user roles (Driver, passenger, disable passenger, rear seat passenger).

In addition, one or more of audio capture devices 452 may capture audio data representative of a soundfield at each of one or more zones 404 (which is another way to refer to audio zones 404). VOS 160A may determine, based on the audio data representative of the soundfield occurring at each of zones 404, that a first user of the multiple users in a first zone (e.g., zone 404C) of the one or more zones is speaking in an attempt to audibly interface with vehicle head unit 202. VOS 160A may adjust, based on the audio data representative of the soundfield occurring at each of zones 404, audio playback at zones 404.

In terms of adjusting audio playback, VOS 160A may determine, based on the audio data representative of the soundfield occurring at each of zones 404, a noise level. VOS 160A may next adjust, based on the noise level, the audio playback at one or more of zones 404.

In this respect, various aspects of the techniques may address how to enable multi-mic support for VOS 160A. VOS 160A may, using audio data captured by audio capture devices 452, determine and/or perform the following;
Use mic to know which user is speaking, talking to adjust the volume controls by recognizing user;
Map to display being used;
Provide better assistant response for the (speaking) user;
Detect noise level for each user (around their respective areas) and perform required audio changes for audio playback for comfortable audio listening;
Also combine audio information for each user to determine noise levels in the car and apply changes to speaker for a better listening environment;

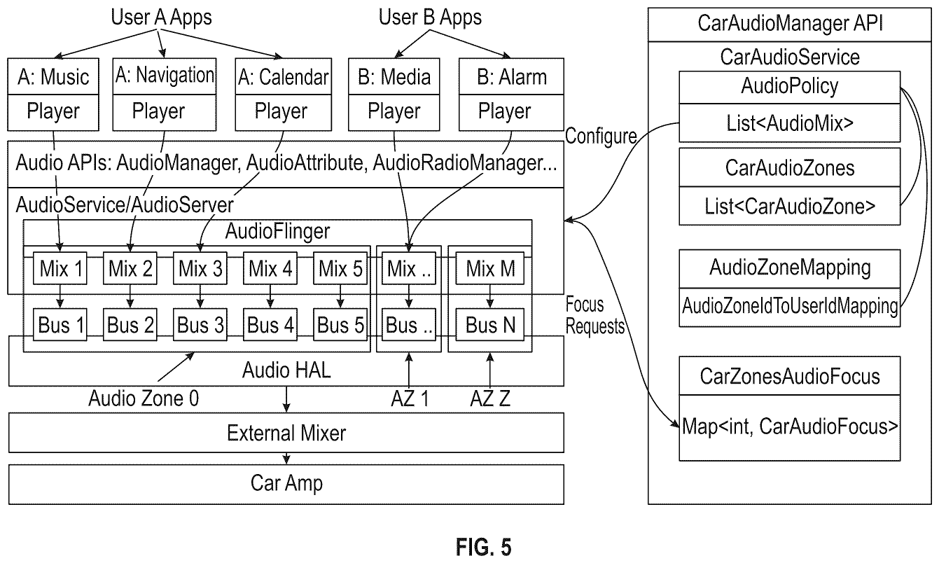

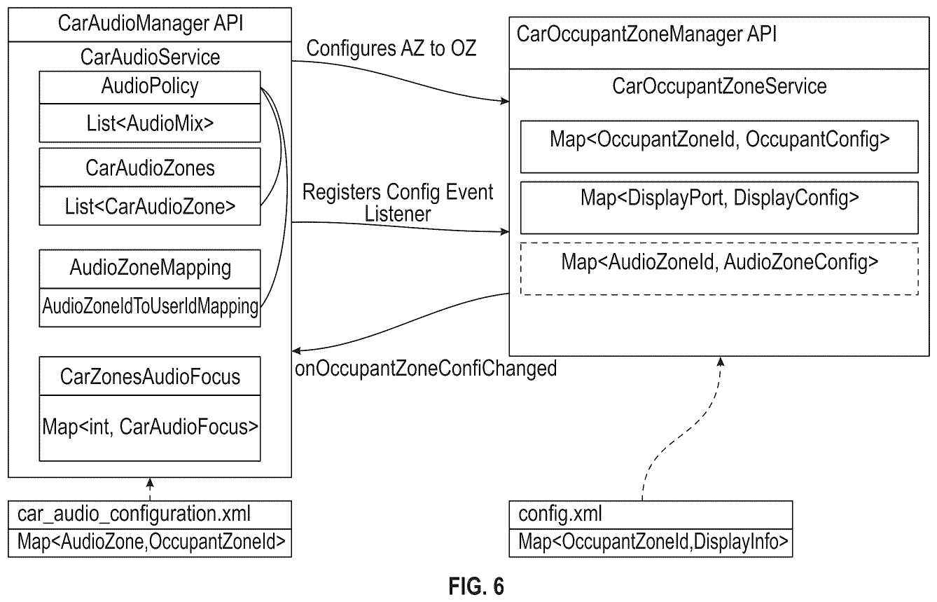

FIGS. 5 and 6 are diagrams illustrating audio control in a single-instance, multi-user vehicle operating system in accordance with various aspects of the techniques described in this disclosure. In some instances, vehicle operating systems have limited scope in that such vehicle operating systems can only send audio from one zone to another for that particular application unique identifier (UID). Various aspects of the techniques described in this disclosure enable zones 404 to share audio to the cabin with the following objectives:
Share media audio from passenger to the main cabin;
Provide a mechanism for passengers not in main cabin to request for audio playback to main zone (e.g., operator zone 404A);
Provide a mechanism for driver to allow audio playback in the main zone;
Provide mechanism to share audio focus between two different zones; and
Disable volume control from non cabin owner from controlling volume;

For example, a passenger listening to media in the rear seat entertainment (RSE) zone (e.g., one of zones 404C or 404D) may send audio to the main cabin to allow for everyone in the car to listen to audio. While the passenger in the back seat RSE would select to send audio to the main cabin, the operator (or main cabin user) would still maintain control of allowing the audio play, as well as retaining control of the volume and other audio settings.

FIG. 5 shows a high level overview of the current audio architecture. Audio zones 404 are defined in configuration are used to set up the audio routing for each audio zone 404. Each of audio zones 404 is defined as a collection of volume groups; each group contains a set of devices that are controlled on volume changes on the volume group. Each device can have different audio context's routed into the device. The vehicle audio service may use the routing information on each audio zone to define a set of audio mixes, which VOS 160A may use to configure the audio routing for each of zones 404.

Referring next to FIG. 6, a configuration set-up is shown between the vehicle audio service and vehicle occupant zone service. For audio, the vehicle audio service may read the audio zone (audioZoneId) to occupant zone Id (occupantZoneId) mapping from the configuration. This information may be sent to the car occupant zone service to set up the occupant zone configuration during initialization. Occupant zone service may maintain information about the occupant zone configuration and display port mapping, which may be read from the different configuration information.

The car audio service may register a VehicleOccupantZoneCallback on the occupant zone service. VOS 160A may trigger this service when there are any of the following changes in the vehicle occupant zone:
Display activation;
Audio Config changes;
Occupant Zone user assignments;
Passenger Start; and
Passenger Stop.

When the audio service receives the onOccupantZoneConfigChanged signal from the callback, the audio service of VOS 160A may automatically assign the users to their corresponding audio zone as follows:
Unloads previous user settings;
Removes previous user audio policy routing;
Loads audio settings for the new user;
Set up audio policy routing for the new user; and
Resets the audio focus mapping for the new user.

The audio service of VOS 160A may use the audio focus mapping to determine where the incoming focus request should be assigned.

To allow for the passenger to send audio to the main cabin there a couple of things that need to be in place:
Handle focus request in main cabin; and
Route passengers audio to the main Cabin
   Once the focus request has successfully changed from the passenger's own audio zone in vehicle 400, the audio routing can take place. For audio playback not yet started, the focus handling will automatically request focus in the main cabin zone with the rules already set with regards to audio usage priority (e.g., audio for media will be rejected by current phone call).

The passenger should be able to request to send audio to the main cabin, a prompt would pop up for the driver to accept. Alternatively, the driver can enable an automatic allow for passengers to play audio. If accepted the audio focus request can be transferred to the main cabin, if needed, and the playback can commence. If not accepted the passenger can be prompted with a message.

Because one goal of the functionality is to play media from passengers in the main cabin, the focus request for the passenger can be restricted to media only. Focus requests for other sounds (e.g. alarm, call, notification, etc.) should remain in the passenger's respective zone. For the media focus request the logic could be as follow:
Send transient focus loss to passengers media apps;
Request Focus for passengers media app in main cabin;
Send focus gain if focus request is granted; and
If not granted due to higher priority sound (emergency, phone call);
   Set focus request as delayed focus;
      Focus will be granted once higher priority focus is done; and
   Alternative: Send focus back to the users zone For passengers, where the user Id is used, a possible driver for audio routing may be the user id device affinity routing. This can still be utilized for sending the passengers audio to the main cabin as follows:
Find the main's cabin media device (preferably a separate high quality device); and
Reset the passenger device affinity to share the cabin's media device.

In addition, multi-zone audio (MZA) may facilitate playback of audio by various users, all playing audio on each individual audio zone 404. This may allow for users in the main cabin to play media or any other sounds, while users in a rear entertainment system also play media in their respective zones. This enables OEMs to potentially design complex audio infotainment systems where each passenger can tailor their own experience in vehicle 400.

Example use cases include the following:
In the car, the driver can play music while users in the backseat can have their own music/media played;
Users in the backseat can control their music volume without affecting the music playback of the driver;
First party music apps launched in the backseat can play sound in the backseat without any change.

One mechanism used for MZA is based on the dynamic audio policy, in particular uses the UID/userId based routing. This may allow for the audio policy to define routing based on audio attribute usages, UID, or userId. This may allow for applications or services to leverage the automatic routing of audio as configured by the dynamic audio policy. However, there exist APIs that can be used to route audio outside of the assigned audio devices. This has some impact in the car as applications are able to send audio to a particular zone without the users permission for example:
Rear seat entertainment (RSE) application from user A sending audio directly to the output device for the driver user in the main cabin.
RSE application from user A sending audio directly to the output device for a different RSE assigned to user B.
   This may raise some concerns for the driver safety as the main driver could be distracted upon arrival of an unwanted audio in the main cabin.

One possible goal of this aspect of the techniques is to allow the current dynamic audio policy to continue working but also limit the playback of audio for users (and their respective application/services) to play audio outside of a set of assigned zones, irrespective of the mechanism used to select devices for audio playback. A potential benefit for the users in the car is that such users will be able to consistently listen to audio in the car in a private and consistent manner.

The dynamic audio policy may provide a mechanism to set devices that can be used by a user for automatic routing via an audio policy API. This audio policy API may cither be used or extended to limit application using the audio routing relative to a set of preferred devices to route audio outside of the limits of the audio policy user assignment. This should potentially limit the “forced” routing for devices defined within the audio policy.

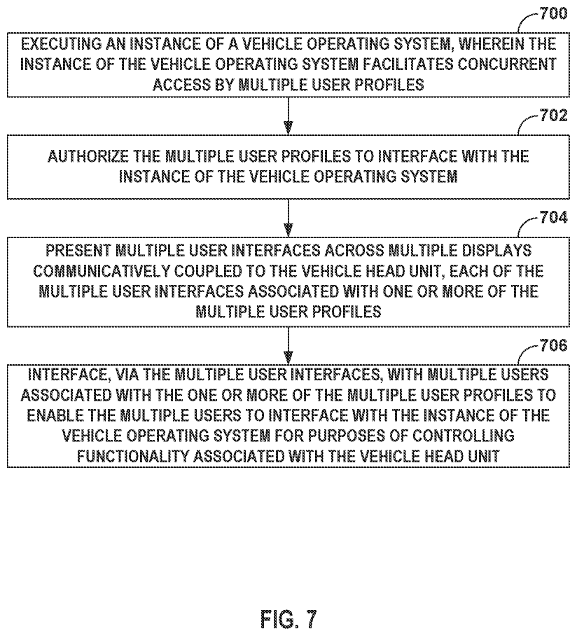

FIG. 7 is a flowchart illustrating example operation of the computing system shown in FIG. 1 in executing a vehicle operating system configured to perform various aspects of the techniques described in this disclosure. As described above, one or more processors 140 of computing device 102 may execute an instance of a vehicle operating system, such as VOS 160A or VOS 160B, wherein VOS 160A and/or 160B facilitates concurrent access by multiple user profiles that are shown in the example of FIG. 1 as user profiles (UP) 161A-161N (“UP 161”) for VOS 160A and UP 163A-163N (“UP 163”) for VOS 160B (700).

Processors 140 may execute, as one example, VOS 160A and authorize multiple user profiles of UP 161 to interface with VOS 160A (702). VOS 160A may present multiple user interfaces across multiple displays (such as display 112 and one or more of displays 150) communicatively coupled to computing device 102 (704). VOS 160A may next interface, via the multiple user interfaces, with multiple users associated with multiple UP of UP 161 to enable the multiple users to interface with VOS 160A for purposes of controlling functionality associated with computing device 102 (706). This functionality may include controlling navigation, changing content playback, changing user interface settings, controlling HVAC settings, sharing content between UP 161, and other functionality described above.

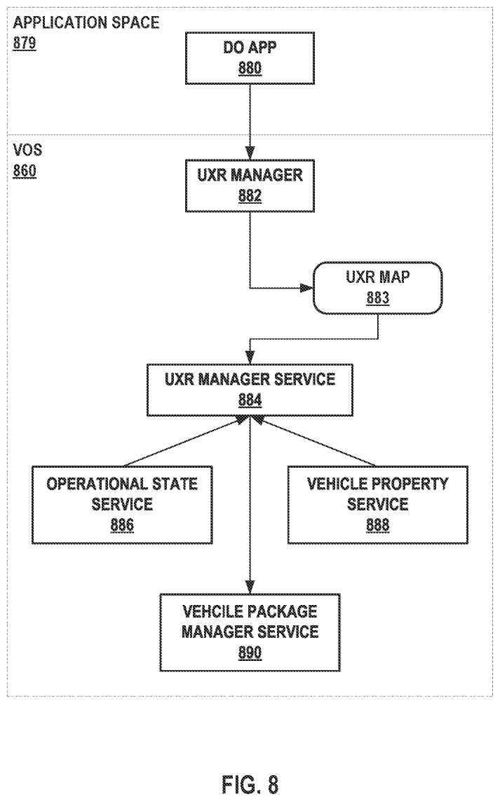

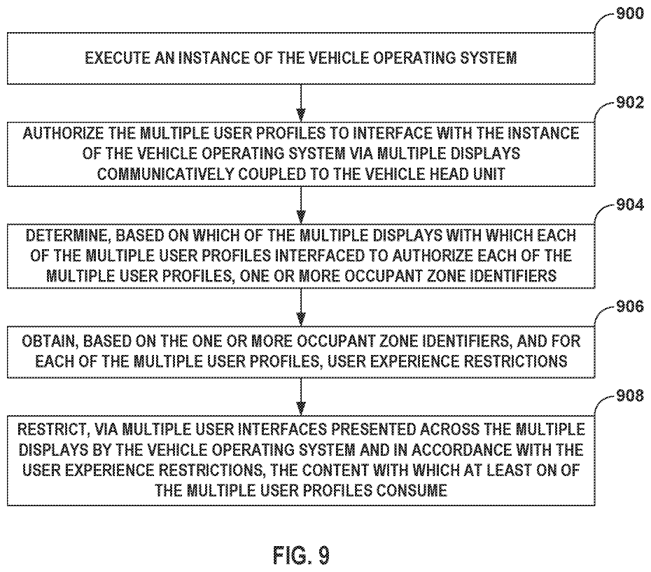

FIG. 8 is a block diagram illustrating the VOS shown in FIG. 1 in providing multi-user experience restrictions according to various aspects of the techniques described in this disclosure. In the example of FIG. 8, VOS 860 may represent one example of VOS 160A and/or VOS 160B shown in the example of FIG. 1. As discussed above, VOS 860 may operate in a kernel space that provides increased privileges (e.g., access rights, dedicated memory, etc.) that hosts an application space 879 have reduced privileges relative to the kemel space in order to moderate access by applications, including distraction optimized (DO) application 880 (“DO application 880,” which may, although not shown in the example of FIG. 1, be stored to storage devices 148).

VOS 860, as further shown in the example of FIG. 1, includes a UXR manager 882, a UXR manager service 884, an operational state server 886, a vehicle property service 888, and a vehicle package manager service 890. UXR manager 882 may represent a software module (executed by underlying hardware, such as processors 140, that cause processors 140) to manage UXR for registered applications (which register via the above noted API, which may be an API exposed by UXR manager 882). DO application 880 may invoke the API to get current UXR for DO application 880, while also registering a listening service for DO application 880 to receive updates to or a replacement for UXR.

UXR manager service 884 may represent a service executing within VOS 860 that manages UXR map 883 based on various properties or updates relative to UP 161/163, DT 171/173, operational state of the vehicle, such as vehicle 200 shown in the example of FIG. 2 (where such operational state may include driving state, idle state, parked state, speed changes, etc.), and application type (which in this example is assumed to be distraction optimized). Operational state service 886 may represent a service of VOS 860 that identifies an operational state of vehicle 200. Vehicle property service 888 may represent a service that identifies various properties (e.g., current speed, seat belt status for occupants, location, mirror configuration, seat configuration, etc.) of vehicle 200. Vehicle package manager service 890 may represent a service responsible for managing UXR for applications throughout the duration of authorization for UP 161/163 to access or otherwise interface with VOS 860, including DO application 880, on a per display basis (whether virtual or physical).

UP 161/163 may initially be authorized to access VOS 860 in the manner described above, whereupon or during authorization, VOS 860 may determine OZID 165/167 as well as possibly DT 171/173 (when virtual displays are present or created by UP 161/163) for each UP 161/163 authorized to access VOS 860. More specifically, UXR manager service 884 may map particular UP 161/163 to one or more of OZID 165/167 and potentially DT 171/173, creating UXR map 883 (which may be updated via UXR manager 882).

UXR manager service 884 may interface with operational state service 886 to obtain a current operational state of vehicle 200. UXR manager service 884 may also interface with vehicle property service 888 to obtain vehicle properties (e.g., speed changes). UXR manager service 884 may determine, based on OZID 165/167 and possibly DT 171/173, the operational state, and vehicle properties, UXR for DO application 880. UXR manager service 884 may provide the determined UXR to vehicle package manager service 890, which performs activity blocking (e.g., restricting content from being consumed via one or more of the multiple displays).

Via the listening service, DO application 880 may receive the UXR and adapt presentation of content to conform to the UXR provided via the listening service. Non-DO applications may, rather than adapt presentation of content to conform to the UXR provided via the listening service, continue to present content without adhering to the provided UXR, at which point vehicle package manager service 890 may perform activity blocking (or, in other words, content restriction) to ensure non-DO applications continue to conform to the determined UXR.

UXR manager service 884 may update UXR map 883 to specify the set of UXR determined for each OZID 165/167 and possible DT 171/173. UXR map 883 may associate (or, in other words, map) operational states (such as a driving state, an idle state, and a parked state) to a set of restrictions that limit presentation of a dial pad (e.g., for initiating a telephone or video call), presentation of a keyboard (e.g., for searching, web browsing, texting, etc.), presentation of video or other content, and/or full restricted (in which case no content or at least the content specified above as a dial pad, keyboard, and video, may be presented). Any changes to UXR map 883 may trigger listening service to issue an interrupt or other flag or mechanism by which to inform DO application 880 of the UXR update and/or changes.

Given that UXR map 883 may be specified granularly on a per display (whether virtual or physical) relative to OZID 165/167, UXR map 883 may allow for different UXR for each display communicatively coupled to VOS 860. As such, VOS 860 may assign display 250A different UXR than display 250B despite both of display 250A and 250B being rear passenger displays for which distraction is not generally considered a safety concem in terms of distracting the operator sitting in the front driver occupant zone of vehicle 200. In instances where content is shared or there is collaboration between different occupant zones as described above, each individual UXR for each occupant zone may be enforced, which may result in different user experiences suitable for the determined level of distraction to the operator sitting in the front operator occupant zone of the vehicle.

While described above with respect to occupant zone identifier, VOS 860 may continue to rely on a physical port for physical displays that do not allow for the creation or support of virtual displays. That is, VOS 860 may maintain backwards compatibility with identifying displays based on a physical port (or a virtual port for wireless physical displays) by which physical displays are communicatively coupled to vehicle head unit 202 and/or VOS 860. In other words, while VOS 860 may support an extension in which OZID 165/167 and possible DT 171/173 are used to uniquely identify both physical displays and virtual displays, VOS 860 may continue to support physical port identifiers for uniquely identifying physical displays in order to maintain backward compatibility.

FIG. 9 is a flowchart illustrating example operation of VOS shown in the example of FIG. 8 in performing various aspects of the techniques described in this disclosure. A vehicle head unit, such as a vehicle head unit 102 and/or 202 shown in the examples of FIGS. 1 and/or 2, may execute an instance of a vehicle operating system (such as vehicle operating system 860), which may facilitate concurrent access by multiple user profiles (900). VOS 860 may authorize multiple UP 161/163 to interface with VOS 160 via multiple displays (e.g., display 212, virtual displays 213A/213B, physical displays 250A/250B) to interface with VOS 860 via multiple displays 212/213/250 communicatively coupled to vehicle head unit 102/202 (902).

VOS 860 may determine, based on which of multiple displays 212/213/250 with which each of UP 161/163 interfaced to authorize each of UP 161/163, one or more OZIDs 165/167 (904). VOS 860 may obtain, based on OZIDs 165/167, and for each of UP 165/167, user experience restrictions (UXR) that restrict content presented via each of displays 212/213/250 for each of UP 161/163 (906). VOS 860 may next restrict, via multiple user interfaces presented across multiple displays 212/213/250 by VOS 860 and in accordance with UXR, the content with which at least one of UP 161/163 consume (908).

In this way, the above described techniques may enable the following examples:

Example 1. A method comprising: executing, by a vehicle head unit, an instance of a vehicle operating system, wherein the instance of the vehicle operating system facilitates concurrent access by multiple user profiles; authorizing, by the instance of the vehicle operating system, the multiple user profiles to interface with the instance of the vehicle operating system; presenting, by the instance of the vehicle operating system, multiple user interfaces across multiple displays communicatively coupled to the vehicle head unit, each of the multiple user interfaces associated with one or more of the multiple user profiles; and interfacing, via the multiple user interfaces, with multiple users associated with the one or more of the multiple user profiles to enable the multiple users to interface with the instance of the vehicle operating system for purposes of controlling functionality associated with the vehicle head unit.

Example 2. The method of example 1, wherein the instance of a vehicle operating system comprises a first instance of the vehicle operating system, wherein the method further comprises executing a second instance of the vehicle operating system, and wherein the first instance of the vehicle operating system includes an interface by which to communicate with the second instance of the vehicle operating system to facilitate concurrent access by the multiple user profiles.

Example 3. The method of example 2, wherein the vehicle head unit includes a high processing capacity processor that executes the first instance of the vehicle operating system, wherein the vehicle head unit includes a low processing capacity processor that executes the second instance of the vehicle operating system, and wherein the high processing capacity processor provides more processing capacity than the low processing capacity processor.

Example 4. The method of any combination of examples 1-3, wherein the multiple displays are displaced about a cabin of a vehicle that includes the vehicle head unit.

Example 5. The method of any combination of examples 1-4, wherein the multiple displays includes two or more of: a first display integrated into an operator side of a front dashboard of a cabin of a vehicle that includes the vehicle head unit; a second display integrated into a center console of the front dashboard; a third display integrated into a passenger side of the front dashboard; and a fourth display integrated into a rear passenger compartment of the cabin.

Example 6. The method of any combination of examples 1-5, wherein the multiple displays include one or more computing devices associated with at least one of the multiple users that is a passenger of a vehicle that includes the vehicle head unit.

Example 7. The method of any combination of examples 1-6, wherein interfacing with the multiple users associated with the one or more of the multiple user profiles includes interfacing with the multiple users to control audio playback within one or more zones of a cabin of a vehicle that includes the vehicle head unit.

Example 8. The method of example 7, wherein the one or more zones of the cabin include one or more of a front operator zone, a front passenger zone, an operator-side rear passenger zone, and a passenger-side rear passenger zone.

Example 9. The method of any combination of examples 7 and 8, wherein interfacing with the multiple users to control the audio playback includes interfacing with the multiple users to control audio volume in a single one of the one or more zones of the cabin.

Example 10. The method of any combination of examples 7-9, wherein interfacing with the multiple users to control the audio playback includes interfacing with the multiple users to control a focus of audio playback in at least one of the one or more zones of the cabin.

Example 11. The method of any combination of examples 7-10, further comprising capturing, by one or more audio capture devices communicatively coupled to the vehicle head unit, audio data representative of a soundfield at each of the one or more zones.

Example 12. The method of example 11, further comprising determining, based on the audio data representative of the soundfield occurring at each of the one or more zones, that a first user of the multiple users in a first zone of the one or more zones is speaking in an attempt to audibly interface with the vehicle head unit.

Example 13. The method of any combination of examples 11 and 12, further comprising adjusting, based on the audio data representative of the soundfield occurring at each of the one or more zones, audio playback at the one or more zones.

Example 14. The method of example 13, wherein adjusting the audio playback includes: determining, based on the audio data representative of the soundfield occurring at each of the one or more zones, a noise level; and adjusting, based on the noise level, the audio playback at the one or more zones.

Example 15. The method of any combination of examples 1-14, wherein interfacing with the multiple users associated with the one or more of the multiple user profiles includes interfacing, via a first user interface of the multiple user interfaces associated with a first user profile of the multiple user profiles, with a first user of the multiple users to interact with content presented by a second user interface of the multiple user interfaces associated with a second user profile of the multiple user profiles.

Example 16. The method of example 15, wherein interfacing with the first user comprises interfacing with the first user to one or more of view or initiate playback, at the first user interface, the content presented by the second user interface.

Example 17. The method of any combination of examples 15 and 16, wherein interfacing with the first user of the multiple users comprises interfacing with the first user to control audio playback by the second user interface.

Example 18. The method of example 17, wherein interfacing with the first user to control the audio playback comprises interfacing with the first user to, via the first user interface, change an audio volume associated with the audio playback by the second user interface.

Example 19. The method of any combination of examples 15-18, wherein interfacing with the first user comprises interfacing with the first user to enable the first user and the second user to jointly interact with the content presented by the second user interface.

Example 20. The method of example 19, wherein interfacing with the first user to enable the first user and the second user to jointly interact with the content comprises interfacing with the first user to enable the first user and the second user to jointly contribute to audio playback by the second user interface.

Example 21. The method of any combination of examples 19 and 20, wherein interfacing with the first user to enable the first user and the second user to jointly interact with the content comprises interfacing with the first user to enable the first user and the second user to jointly contribute to a multi-user activity presented by the second user interface.

Example 22. The method of example 21, wherein the multi-user activity comprises a navigation activity in which both the first user and the second user contribute to navigation of a vehicle that includes the vehicle head unit.

Example 23. The method of any combination of examples 21 and 22, wherein the multi-user activity comprises a multi-player video game presented by the second user interface.

Example 24. The method of any combination of examples 1-23, wherein interfacing with the multiple users associated with the one or more of the multiple user profiles includes interfacing, via a first user interface of the multiple user interfaces associated with a first user profile of the multiple user profiles, with a first user of the multiple users to share content presented by the first user interface with a second user interface of the multiple user interfaces associated with a second user profile of the multiple user profiles.

Example 25. The method of example 24, wherein interfacing with the first user comprises receiving, at the first user interface, a gesture that indicates the content presented by the first user interface is to be shared with the second user interface.

Example 26. The method of example 25, wherein the gesture includes one or more of a swipe gesture, a pinch gesture, and a tap gesture.

Example 27. The method of any combination of examples 24-26, further comprising presenting, by the first user interface, an animation indicating initiation of the content being shared.

Example 28. The method of any combination of examples 24-27, further comprising playing audio indicating initiation of the content being shared.

Example 29. The method of example 28, wherein playing the audio comprises playing spatialized audio to reflect a position of the first user interface relative to a position of the second user interface.

Example 30. A computing device comprising: a memory configured to store an instance of a vehicle operating system, wherein the instance of the vehicle operating system facilitates concurrent access by multiple user profiles; one or more processors to execute the instance of the vehicle operating system, wherein the instance of the vehicle operating system is configured to: authorize the multiple user profiles to interface with the instance of the vehicle operating system; and present multiple user interfaces across multiple displays communicatively coupled to the vehicle head unit, each of the multiple user interfaces associated with one or more of the multiple user profiles, wherein the multiple user interfaces are configured to interface with multiple users associated with the one or more of the multiple user profiles to enable the multiple users to interface with the instance of the vehicle operating system for purposes of controlling functionality associated with the vehicle head unit.

Example 31. The computing device of example 30, wherein the instance of a vehicle operating system comprises a first instance of the vehicle operating system, wherein the one or more processors are further configured to execute a second instance of the vehicle operating system, and wherein the first instance of the vehicle operating system includes an interface by which to communicate with the second instance of the vehicle operating system to facilitate concurrent access by the multiple user profiles.

Example 32. The computing device of example 31, wherein the one or more processors include a high processing capacity processor that executes the first instance of the vehicle operating system, wherein one or more processors include a low processing capacity processor that executes the second instance of the vehicle operating system, and wherein the high processing capacity processor provides more processing capacity than the low processing capacity processor.

Example 33. The computing device of any combination of examples 30-32, wherein the multiple displays are displaced about a cabin of a vehicle that includes the vehicle head unit.

Example 34. The computing device of any combination of examples 30-33, wherein the multiple displays includes two or more of: a first display integrated into an operator side of a front dashboard of a cabin of a vehicle that includes the vehicle head unit; a second display integrated into a center console of the front dashboard; a third display integrated into a passenger side of the front dashboard; and a fourth display integrated into a rear passenger compartment of the cabin.

Example 35. The computing device of any combination of examples 30-34, wherein the multiple displays include one or more computing devices associated with at least one of the multiple users that is a passenger of a vehicle that includes the vehicle head unit.

Example 36. The computing device of any combination of examples 30-35, wherein the multiple user interfaces are configured to interface with the multiple users to control audio playback within one or more zones of a cabin of a vehicle that includes the vehicle head unit.

Example 37. The computing device of example 36, wherein the one or more zones of the cabin include one or more of a front operator zone, a front passenger zone, an operator-side rear passenger zone, and a passenger-side rear passenger zone.

Example 38. The computing device of any combination of examples 36 and 37, wherein the multiple user interfaces are configured to interface with the multiple users to control audio volume in a single one of the one or more zones of the cabin.

Example 39. The computing device of any combination of examples 36-38, wherein the multiple user interfaces are configured to interface with the multiple users to control a focus of audio playback in at least one of the one or more zones of the cabin.

Example 40. The computing device of any combination of examples 36-39, further comprising one or more audio capture devices configured to capture audio data representative of a soundfield at each of the one or more zones.

Example 41. The computing device of example 40, wherein the instance of the vehicle operating system is further configured to determine, based on the audio data representative of the soundfield occurring at each of the one or more zones, that a first user of the multiple users in a first zone of the one or more zones is speaking in an attempt to audibly interface with the vehicle head unit.

Example 42. The computing device of any combination of examples 40 and 41, wherein the instance of the vehicle operating system is further configured to adjust, based on the audio data representative of the soundfield occurring at each of the one or more zones, audio playback at the one or more zones.

Example 43. The computing device of example 42, wherein the instance of the vehicle operating system is further configured to: determine, based on the audio data representative of the soundfield occurring at each of the one or more zones, a noise level; and adjust, based on the noise level, the audio playback at the one or more zones.

Example 44. The computing device of any combination of examples 30-43, wherein a first user interface of the multiple user interfaces associated with a first user profile of the multiple user profiles is configured to interface with a first user of the multiple users to interact with content presented by a second user interface of the multiple user interfaces associated with a second user profile of the multiple user profiles.

Example 45. The computing device of example 44, wherein the first user interface of the multiple user interfaces associated with the first user profile of the multiple user profiles is configured to interface with the first user to one or more of view or initiate playback, at the first user interface, the content presented by the second user interface.

Example 46. The computing device of any combination of examples 44 and 45, wherein the first user interface of the multiple user interfaces associated with the first user profile of the multiple user profiles is configured to interface with the first user to control audio playback by the second user interface.

Example 47. The computing device of example 46, wherein the first user interface of the multiple user interfaces associated with the first user profile of the multiple user profiles is configured to interface with the first user to, via the first user interface, change an audio volume associated with the audio playback by the second user interface.

Example 48. The computing device of any combination of examples 44 and 45, wherein the first user interface of the multiple user interfaces associated with the first user profile of the multiple user profiles is configured to interface with the first user to enable the first user and the second user to jointly interact with the content presented by the second user interface.

Example 49. The computing device of example 48, wherein the first user interface of the multiple user interfaces associated with the first user profile of the multiple user profiles is configured to interface with the first user to enable the first user and the second user to jointly contribute to audio playback by the second user interface.

Example 50. The computing device of any combination of examples 48 and 49, wherein the first user interface of the multiple user interfaces associated with the first user profile of the multiple user profiles is configured to interface with the first user to enable the first user and the second user to jointly contribute to a multi-user activity presented by the second user interface.

Example 51. The computing device of example 50, wherein the multi-user activity comprises a navigation activity in which both the first user and the second user contribute to navigation of a vehicle that includes the vehicle head unit.

Example 52. The computing device of any combination of examples 50 and 51, wherein the multi-user activity comprises a multi-player video game presented by the second user interface.

Example 53. The computing device of any combination of examples 30-52, wherein the first user interface of the multiple user interfaces associated with the first user profile of the multiple user profiles is configured to interface with a first user of the multiple users to share content presented by the first user interface with a second user interface of the multiple user interfaces associated with a second user profile of the multiple user profiles.

Example 54. The computing device of example 53, wherein the first user interface of the multiple user interfaces associated with the first user profile of the multiple user profiles is configured to receive a gesture that indicates the content presented by the first user interface is to be shared with the second user interface.

Example 55. The computing device of example 54, wherein the gesture includes one or more of a swipe gesture, a pinch gesture, and a tap gesture.

Example 56. The computing device of any combination of examples 53-55, wherein the first user interface is further configured to present an animation indicating initiation of the content being shared.

Example 57. The computing device of any combination of examples 53-56, wherein the first user interface is further configured to play audio indicating initiation of the content being shared.

Example 58. The computing device of example 57, wherein the first user interface is configured to play spatialized audio to reflect a position of the first user interface relative to a position of the second user interface.

Example 59. A non-transitory computer-readable storage medium having instructions stored thereon that, when executed, cause one or more processors to: execute an instance of a vehicle operating system, wherein the instance of the vehicle operating system facilitates concurrent access by multiple user profiles; authorize, via execution of the first instance of the vehicle operating system, the multiple user profiles to interface with the instance of the vehicle operating system; present, via execution of the first instance of the vehicle operating system, multiple user interfaces across multiple displays communicatively coupled to the vehicle head unit, each of the multiple user interfaces associated with one or more of the multiple user profiles; and interface, via the multiple user interfaces, with multiple users associated with the one or more of the multiple user profiles to enable the multiple users to interface with the instance of the vehicle operating system for purposes of controlling functionality associated with the vehicle head unit.

Example 1A. A method comprising: executing, by a vehicle head unit included in a vehicle, an instance of a vehicle operating system, wherein the instance of the vehicle operating system facilitates concurrent access by multiple user profiles; authorizing, by the instance of the vehicle operating system, the multiple user profiles to interface with the instance of the vehicle operating system via multiple displays communicatively coupled to the vehicle head unit; determining, based on which of the multiple displays with which each of the multiple user profiles interfaced to authorize each of the multiple user profiles, one or more occupant zone identifiers, each of the one or more occupant zone identifiers identifying an occupant zone of the vehicle in which each of the multiple user profiles are associated; obtaining, based on the one or more occupant zone identifiers, and for each of the multiple user profiles, user experience restrictions that restrict content presented via each of the multiple displays for each of the multiple user profiles; and restricting, via multiple user interfaces presented across the multiple displays by the single instance of the vehicle operating system and in accordance with the user experience restrictions, the content with which at least one of the multiple user profiles consume.

Example 2A, The method of example 1A, further comprising determining a display type for each of the multiple displays, wherein the display type indicates that at least one of the multiple displays is a virtual display that is presented by at least one physical display of the multiple displays.

Example 3A. The method of example 2A, wherein the at least one virtual display is presented concurrently with another virtual display of the multiple displays via the at least one physical display.

Example 4A. The method of examples 2A or 3A, further comprising obtaining a operational state of the vehicle, wherein obtaining the user experience restrictions includes obtaining, based on the occupant zone identifier, the display type, and the operational state, the user experience restrictions.

Example 5A. The method of example 4A, wherein obtaining the operational state comprises obtaining one of a driving state, an idle state, and a parked state, wherein obtaining the user experience restrictions includes one of obtaining first user experience restrictions based on the driving state, obtaining second user experience restrictions based on the idle state, and obtaining third user experience restrictions based on the parked state, wherein the first user experience restrictions are more limiting than the second user experience restrictions, and wherein the second user experience restrictions are more limiting than the third user experience restrictions.

Example 6A. The method of examples 1A-5A, further comprising: receiving, via an application programming interface and for the occupant zone identifier, a registration for the user experience restrictions; and updating, based on the registration for the user experience restrictions, the user experience restrictions for at least one client application.

Example 7A. The method of example 6A, wherein the at least one client application includes a non-distraction optimized application, and wherein the user experience restrictions for the non-distraction optimized application is more limiting than user experience restrictions for a distraction optimized application.

Example 8A. The method of examples 1A-7A, wherein the instance of a vehicle operating system comprises a first instance of the vehicle operating system, wherein the method further comprises executing a second instance of the vehicle operating system, and wherein the first instance of the vehicle operating system includes an interface by which to communicate with the second instance of the vehicle operating system to facilitate concurrent access by the multiple user profiles.

Example 9A. The method of examples 1A-8A, wherein the multiple displays are displaced about a cabin of the vehicle that includes the vehicle head unit.

Example 10A. The method of examples 1A-9A, wherein the multiple displays includes two or more of: a first display integrated into an operator side of a front dashboard of a cabin of the vehicle that includes the vehicle head unit; a second display integrated into a center console of the front dashboard; a third display integrated into a passenger side of the front dashboard; and a fourth display integrated into a rear passenger compartment of the cabin.

Example 11A. The method of examples 1A-10A, wherein the occupant zone includes one of a front operator zone, a front passenger zone, an operator-side rear passenger zone, and a passenger-side rear passenger zone.

Example 12A. A computing device comprising: a memory configured to store an instance of a vehicle operating system, wherein the instance of the vehicle operating system facilitates concurrent access by multiple user profiles; processing circuitry configured to execute the instance of the vehicle operating system, wherein the instance of the vehicle operating system is configured to: authorize the multiple user profiles to interface with the instance of the vehicle operating system via multiple displays communicatively coupled to the vehicle head unit; determine, based on which of the multiple displays with which each of the multiple user profiles interfaced to authorize each of the multiple user profiles, one or more occupant zone identifiers, each of the one or more occupant zone identifiers identifying an occupant zone of the vehicle in which each of the multiple user profiles are associated; obtain, based on the one or more occupant zone identifiers, and for each of the multiple user profiles, user experience restrictions that restrict content presented via each of the multiple displays for each of the multiple user profiles; and restrict, via multiple user interfaces presented across the multiple displays by the single instance of the vehicle operating system and in accordance with the user experience restrictions, the content with which at least one of the multiple user profiles consume.

Example 13A. The computing device of example 12A, wherein the vehicle operating system is further configured to determine a display type for each of the multiple displays, wherein the display type indicates that at least one of the multiple displays is a virtual display that is presented by at least one physical display of the multiple displays.

Example 14A. The computing device of example 13A, wherein the at least one virtual display is presented concurrently with another virtual display of the multiple displays via the at least one physical display.

Example 15A. The computing device of examples 13A or 15A, wherein the vehicle operating system is further configured to obtain a operational state of the vehicle, wherein the vehicle operating system is configured to obtain, based on the occupant zone identifier, the display type, and the operational state, the user experience restrictions.

Example 16A. The computing device of example 15A, wherein the vehicle operating system is configured to obtain one of a driving state, an idle state, and a parked state, wherein the vehicle operating system is configured to obtain one or more of first user experience restrictions based on the driving state, second user experience restrictions based on the idle state, and third user experience restrictions based on the parked state, wherein the first user experience restrictions are more limiting than the second user experience restrictions, and wherein the second user experience restrictions are more limiting than the third user experience restrictions.

Example 17A. The computing device of examples 12A-16A, wherein the vehicle operating system is further configured to: receive, via an application programming interface and for the occupant zone identifier, a registration for the user experience restrictions; and update, based on the registration for the user experience restrictions, the user experience restrictions for at least one client application.

Example 18A. The computing device of example 17A, wherein the at least one client application includes a non-distraction optimized application, and wherein the user experience restrictions for the non-distraction optimized application is more limiting than user experience restrictions for a distraction optimized application.

Example 19A. The computing device of examples 12A-18A, wherein the instance of a vehicle operating system comprises a first instance of the vehicle operating system, wherein the processing circuitry is further configured to execute a second instance of the vehicle operating system, and wherein the first instance of the vehicle operating system includes an interface by which to communicate with the second instance of the vehicle operating system to facilitate concurrent access by the multiple user profiles.

Example 20A. A non-transitory computer-readable storage medium having instructions stored thereon that, when executed, cause one or more processors to: execute an instance of a vehicle operating system, wherein the instance of the vehicle operating system facilitates concurrent access by multiple user profiles; authorize, via execution of the first instance of the vehicle operating system, the multiple user profiles to interface with the instance of the vehicle operating system; determine, based on which of the multiple displays with which each of the multiple user profiles interfaced to authorize each of the multiple user profiles, one or more occupant zone identifiers, each of the one or more occupant zone identifiers identifying an occupant zone of the vehicle in which each of the multiple user profiles are associated; obtain, based on the one or more occupant zone identifiers, and for each of the multiple user profiles, user experience restrictions that restrict content presented via each of the multiple displays for each of the multiple user profiles; and restrict, via multiple user interfaces presented across the multiple displays by the single instance of the vehicle operating system and in accordance with the user experience restrictions, the content with which at least one of the multiple user profiles consume.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium, For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, ultra Blu-ray, etc. where disks usually reproduce data magnetically, while discs reproduce data optically with lasers.

Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A method comprising:
executing, by a vehicle head unit included in a vehicle, an instance of a vehicle operating system, wherein the instance of the vehicle operating system facilitates concurrent access by multiple user profiles;
authorizing, by the instance of the vehicle operating system, the multiple user profiles to interface with the instance of the vehicle operating system via multiple displays communicatively coupled to the vehicle head unit;
determining, based on which of the multiple displays with which each of the multiple user profiles interfaced to authorize each of the multiple user profiles, one or more occupant zone identifiers, each of the one or more occupant zone identifiers identifying an occupant zone of the vehicle in which each of the multiple user profiles are associated;
obtaining, based on the one or more occupant zone identifiers, and for each of the multiple user profiles, user experience restrictions that restrict content presented via each of the multiple displays for each of the multiple user profiles; and
restricting, via multiple user interfaces presented across the multiple displays by the single instance of the vehicle operating system and in accordance with the user experience restrictions, the content with which at least one of the multiple user profiles consume.

2. The method of claim 1, further comprising determining a display type for each of the multiple displays, wherein the display type indicates that at least one of the multiple displays is a virtual display that is presented by at least one physical display of the multiple displays.

3. The method of claim 2, wherein the at least one virtual display is presented concurrently with another virtual display of the multiple displays via the at least one physical display.

4. The method of claim 2, further comprising obtaining a operational state of the vehicle,
wherein obtaining the user experience restrictions includes obtaining, based on the occupant zone identifier, the display type, and the operational state, the user experience restrictions.

5. The method of claim 4,
wherein obtaining the operational state comprises obtaining one of a driving state, an idle state, and a parked state,
wherein obtaining the user experience restrictions includes one of obtaining first user experience restrictions based on the driving state, obtaining second user experience restrictions based on the idle state, and obtaining third user experience restrictions based on the parked state,
wherein the first user experience restrictions are more limiting than the second user experience restrictions, and
wherein the second user experience restrictions are more limiting than the third user experience restrictions.

6. The method of claim 1, further comprising:
receiving, via an application programming interface and for the occupant zone identifier, a registration for the user experience restrictions; and
updating, based on the registration for the user experience restrictions, the user experience restrictions for at least one client application.

7. The method of claim 6,
wherein the at least one client application includes a non-distraction optimized application, and
wherein the user experience restrictions for the non-distraction optimized application is more limiting than user experience restrictions for a distraction optimized application.

8. The method of claim 1,
wherein the instance of a vehicle operating system comprises a first instance of the vehicle operating system,
wherein the method further comprises executing a second instance of the vehicle operating system, and
wherein the first instance of the vehicle operating system includes an interface by which to communicate with the second instance of the vehicle operating system to facilitate concurrent access by the multiple user profiles.

9. The method of claim 1, wherein the multiple displays are displaced about a cabin of the vehicle that includes the vehicle head unit.

10. The method of claim 1, wherein the multiple displays includes two or more of:
a first display integrated into an operator side of a front dashboard of a cabin of the vehicle that includes the vehicle head unit;
a second display integrated into a center console of the front dashboard;
a third display integrated into a passenger side of the front dashboard; and
a fourth display integrated into a rear passenger compartment of the cabin.

11. The method of claim 1, wherein the occupant zone includes one of a front operator zone, a front passenger zone, an operator-side rear passenger zone, and a passenger-side rear passenger zone.

12. A computing device comprising:
a memory configured to store an instance of a vehicle operating system, wherein the instance of the vehicle operating system facilitates concurrent access by multiple user profiles;
processing circuitry configured to execute the instance of the vehicle operating system,
wherein the instance of the vehicle operating system is configured to:
authorize the multiple user profiles to interface with the instance of the vehicle operating system via multiple displays communicatively coupled to the vehicle head unit;
determine, based on which of the multiple displays with which each of the multiple user profiles interfaced to authorize each of the multiple user profiles, one or more occupant zone identifiers, each of the one or more occupant zone identifiers identifying an occupant zone of the vehicle in which each of the multiple user profiles are associated;
obtain, based on the one or more occupant zone identifiers, and for each of the multiple user profiles, user experience restrictions that restrict content presented via each of the multiple displays for each of the multiple user profiles; and
restrict, via multiple user interfaces presented across the multiple displays by the single instance of the vehicle operating system and in accordance with the user experience restrictions, the content with which at least one of the multiple user profiles consume.

13. The computing device of claim 12, wherein the vehicle operating system is further configured to determine a display type for each of the multiple displays, wherein the display type indicates that at least one of the multiple displays is a virtual display that is presented by at least one physical display of the multiple displays.

14. The computing device of claim 13, wherein the at least one virtual display is presented concurrently with another virtual display of the multiple displays via the at least one physical display.

15. The computing device of claim 13, wherein the vehicle operating system is further configured to obtain an operational state of the vehicle,
wherein the vehicle operating system is configured to obtain, based on the occupant zone identifier, the display type, and the operational state, the user experience restrictions.

16. The computing device of claim 15,
wherein the vehicle operating system is configured to obtain one of a driving state, an idle state, and a parked state,
wherein the vehicle operating system is configured to obtain one or more of first user experience restrictions based on the driving state, second user experience restrictions based on the idle state, and third user experience restrictions based on the parked state,
wherein the first user experience restrictions are more limiting than the second user experience restrictions, and
wherein the second user experience restrictions are more limiting than the third user experience restrictions.

17. The computing device of claim 12, wherein the vehicle operating system is further configured to:
receive, via an application programming interface and for the occupant zone identifier, a registration for the user experience restrictions; and
update, based on the registration for the user experience restrictions, the user experience restrictions for at least one client application.

18. The computing device of claim 17,
wherein the at least one client application includes a non-distraction optimized application, and
wherein the user experience restrictions for the non-distraction optimized application is more limiting than user experience restrictions for a distraction optimized application.

19. The computing device of claim 12,
wherein the instance of a vehicle operating system comprises a first instance of the vehicle operating system,
wherein the processing circuitry is further configured to execute a second instance of the vehicle operating system, and
wherein the first instance of the vehicle operating system includes an interface by which to communicate with the second instance of the vehicle operating system to facilitate concurrent access by the multiple user profiles.

20. A non-transitory computer-readable storage medium having instructions stored thereon that, when executed, cause one or more processors to:
execute an instance of a vehicle operating system, wherein the instance of the vehicle operating system facilitates concurrent access by multiple user profiles;
authorize, via execution of the first instance of the vehicle operating system, the multiple user profiles to interface with the instance of the vehicle operating system;
determine, based on which of the multiple displays with which each of the multiple user profiles interfaced to authorize each of the multiple user profiles, one or more occupant zone identifiers, each of the one or more occupant zone identifiers identifying an occupant zone of the vehicle in which each of the multiple user profiles are associated;
obtain, based on the one or more occupant zone identifiers, and for each of the multiple user profiles, user experience restrictions that restrict content presented via each of the multiple displays for each of the multiple user profiles; and
restrict, via multiple user interfaces presented across the multiple displays by the single instance of the vehicle operating system and in accordance with the user experience restrictions, the content with which at least one of the multiple user profiles consume.
